(19) United States
(12) Patent Application Publication
(10) Pub. No.: US 2019/0113784 A1
(43) Pub. Date: Apr. 18, 2019

(54) LIQUID CRYSTAL DISPLAY DEVICE

(71) Applicant: SHARP KABUSHIKI KAISHA, Sakai City, Osaka (JP)

(72) Inventors: YOSUKE IWATA, Sakai City (JP); MITSUHIRO MURATA, Sakai City (JP); TAKUMA TOMOTOSHI, Sakai City (JP)

(21) Appl. No.: 16/090,164

(22) PCT Filed: Mar. 21, 2017
(86) PCT No.: PCT/JP2017/011151

§ 371 Date: Sep. 28, 2018

(30) Foreign Application Priority Data
Mar. 28, 2016 (JP) 2016-064330

(51) Int. Cl. G02F 1/1337; G02F 1/1343; G02F 1/137

(52) U.S. Cl. CPC G02F 1/1337; G02F 1/134309; G02F 2001/13712; G02F 2201/123; G02F 2001/13706; G02F 1/137

(57) ABSTRACT

The present invention provides a horizontal alignment mode liquid crystal display device capable of achieving high resolution and improving transmittance. The liquid crystal display device according to the present invention sequentially includes: a first substrate; a liquid crystal layer; and a second substrate, wherein the first substrate includes a first electrode, a second electrode provided closer to the liquid crystal layer than the first electrode is, and an insulating film provided between the first electrode and the second electrode, an opening is formed in the second electrode, the liquid crystal molecules are aligned parallel to the first substrate in a voltage non-applied state, and with a contour of the opening divided into four by a first straight line longest among lines dividing the opening in the direction parallel to an initial alignment azimuth direction of the liquid crystal molecules and a second straight line longest among lines dividing the opening in the direction orthogonal to the initial alignment azimuth direction, the sign of the average slope of each of the divided contour portions differs from the signs of the average slopes of two adjacent contour portions, and the average slope of the entire contour of the opening is not zero.

### TECHNICAL FIELD

The present invention relates to a liquid crystal display device. More specifically, the present invention relates to a liquid crystal display device suitable for providing high-resolution pixels in a horizontal alignment mode.

### BACKGROUND ART

A liquid crystal display device is a display device that uses a liquid crystal composition for display. In a typical display method for this device, a voltage is applied to a liquid crystal composition sealed between a pair of substrates, and the alignment state of the liquid crystal molecules in the liquid crystal composition is changed in accordance with the applied voltage, whereby the light transmission amount is controlled. Such a liquid crystal display device is used in a wide range of fields by taking advantages such as thinness, lightweight, and low power consumption.

As a display method of a liquid crystal display device, a horizontal alignment mode in which control is performed by mainly rotating the alignment of liquid crystal molecules in a plane parallel to the substrate surface has attracted a great deal of attention because, for example, wide viewing angle characteristics can be easily obtained. For example, in recent years, liquid crystal display devices for smartphones and tablet PCs have widely used the in-plane switching (IPS) mode and the fringe field switching (FFS) mode, each of which is one type of horizontal alignment mode.

With respect to such a horizontal alignment mode, research and development have been continued to improve the display quality by, for example, increasing the pixel resolution, improving the transmittance, and improving the response speed. As a technique for improving the response speed, for example, Patent Literature 1 discloses a liquid crystal display device using fringe electric fields, and a technique of providing a comb-tooth portion with a specific shape to a first electrode. In addition, Patent Literature 2 relates to an FFS mode liquid crystal display and discloses an electrode structure having a slit including two linear portions and a V-shaped portion formed by coupling the two linear portions in a V shape. According to this document, this technique can reduce defects caused by process variations and improve the display performance.

### CITATION LIST

### Patent Literature

Patent Literature 1: JP 2015-114493 A
Patent Literature 2: WO 2013/021929 A

### SUMMARY OF INVENTION

### Technical Problem

Although the horizontal alignment mode has an advantage of achieving a wide viewing angle, there is a problem that the response is slow as compared with the vertical alignment mode such as the multi-domain vertical alignment (MVA) mode. Although the response speed can be improved in the horizontal mode by using the technique disclosed in Patent Literature 1, the shape of the electrode is largely restricted by an ultra-high pixel resolution of 800 ppi or more. This makes it difficult to adopt a complicated electrode shape like that disclosed in Patent Literature 1.

According to Patent Literature 2, due to the influence of the V-shaped portion provided in the opening of the electrode, it is possible to improve the display performance such as transmittance by dividing the alignment of the liquid crystal molecules into two regions at the time of voltage application. However, the effect of speeding up is not great. In addition, there is still room for improvement in order to achieve further higher resolution and higher transmittance.

As a result of various studies, the present inventors have found that high speed and high resolution can be achieved in an FFS mode liquid crystal display device even in the horizontal alignment mode by using the strain force generated by the bend-shaped and splay-shaped liquid crystal alignment formed in a narrow region by rotating liquid crystal molecules within a range smaller than a certain pitch at the time of voltage application to form four liquid crystal domains and rotating the liquid crystal molecules in the adjacent liquid crystal domains in mutually opposite azimuth directions. In this case, it is ideal that the four liquid crystal domains are generated symmetrically with respect to each other. Therefore, the opening shape of the upper layer electrode preferably has a shape symmetrical with respect to the initial alignment azimuth direction of liquid crystal molecules, for example, a quadrangular shape with two rounded end portions or an elliptical shape. In this case, ideally, the liquid crystal molecules are not rotated in the central portion of the opening. However, it has been found that when a high voltage is applied, it becomes difficult to stabilize the boundaries (dark lines) between the four liquid crystal domains, and the response characteristic deteriorated.

Therefore, in order to stabilize the dark lines even at the time of applying a high voltage, the present inventors have further studied. FIG. 18 is a schematic plan view showing a counter electrode in an FFS mode liquid crystal display device according to Comparative Embodiment 1 studied by the present inventors. As shown in FIG. 18, in the FFS mode liquid crystal display device according to Comparative Embodiment 1, a counter electrode 14 having an opening 15 is disposed on the upper layer, and a pixel electrode (not shown) is disposed on the lower layer. The opening 15 is constituted by a longitudinal portion 16 and a pair of protruding portions 17 protruding to the opposite sides from the longitudinal portion 16, and has a shape symmetrical with respect to an initial alignment azimuth direction 22 of liquid crystal molecules 21. As shown in FIG. 18, in the FFS mode liquid crystal display device according to Comparative Embodiment 1, rotating the liquid crystal molecules 21 can form four liquid crystal domains in which the alignments of the liquid crystal molecules 21 are symmetrical with respect to each other, and the dark lines between the four liquid crystal domains can be fixed by oblique electric fields in the pair of protruding portions 17.

Actually, however, even when the symmetrical opening 15 including the pair of protruding portions 17 is provided, when a higher voltage is applied and the rotation of the liquid crystal molecules 21 becomes larger, the alignment of the liquid crystal molecules 21 in the central portion of the opening 15 becomes unstable, and the liquid crystal molecules 21 in the central portion of the opening 15 sometimes rotate depending on a unit of display 50. The reason for this is as follows. When a high voltage is applied, the electric field is slightly distorted in the central portion of the opening 15, and the balance of the alignment of the liquid crystal molecules 21 in the central portion of the opening 15 collapses under the influence of the surrounding liquid crystal molecules 21. FIG. 19 is a plan view showing the simulation result of the alignment distribution of the liquid crystal molecules in the ON state in the unit of display of the liquid crystal display device using the counter electrode in FIG. 18. The states of the liquid crystal molecules 21 in the central portions of the openings 15, such as the presence/absence, degree, and direction of rotation, differ for each unit of display 50. Thus, the alignment states of the liquid crystal molecules 21 existing in the central portions of the openings 15 vary depending on the units of display 50, as indicated by two regions surrounded by circles in opening portions 60 in FIG. 19. This means that transmittance varies for each unit of display 50 despite in the same gray scale display. Therefore, even when the opening 15 having a symmetrical shape including the pair of protruding portions 17 is provided, a sufficiently high voltage could not be applied and a sufficient transmittance is difficult to be obtained.

The present invention has been made in view of the above state of the art, and it is an object of the present invention to provide a horizontal alignment mode liquid crystal display device capable of achieving high resolution and improving transmittance.

### Solution to Problem

As a result of extensive studies on a horizontal alignment mode liquid crystal display device capable of achieving high resolution and improving transmittance, the present inventors have focused attention on the shape of the opening of an electrode used for forming a fringe electric field. The present inventors have found that even if the opening shape of the electrode is not complicated, using a shape satisfying two specific conditions makes it possible to rotate the liquid crystal molecules in a predetermined azimuth direction by intentionally distorting the electric field in the central portion of the opening and to stabilize the alignment of liquid crystal molecules in the central portion of the opening. Specifically, when the contour of the opening is divided into four by a first straight line longest among lines dividing the opening in the direction parallel to the initial alignment azimuth direction of liquid crystal molecules and a second straight line longest among lines dividing the opening in the direction orthogonal to the initial alignment azimuth direction, the liquid crystal molecules can be rotated in a predetermined azimuth direction in the central portion of the opening by distorting the electric field because (condition 1) a bend-shaped and splay-shaped liquid crystal alignment can be formed in a narrow region at the time of voltage application since the sign of the average slope of each of the divided contour portions differs from the signs of the average slopes of two adjacent contour portions, and (condition 2) the shape of the opening becomes asymmetrical with respect to the initial alignment azimuth direction of the liquid crystal molecules since the average slope of the entire contour of the opening is not zero. This makes it possible to achieve high resolution and improve the transmittance. That is, the present inventors have satisfactorily achieved the above object, and have reached the present invention.

That is, one aspect of the present invention may be a liquid crystal display device sequentially including: a first substrate; a liquid crystal layer containing liquid crystal molecules; and a second substrate, wherein the first substrate includes a first electrode, a second electrode provided closer to the liquid crystal layer than the first electrode is, and an insulating film provided between the first electrode and the second electrode, an opening is formed in the second electrode, the liquid crystal molecules are aligned parallel to the first substrate in a voltage non-applied state in which no voltage is applied between the first electrode and the second electrode, and with a contour of the opening divided into four by a first straight line longest among lines dividing the opening in the direction parallel to an initial alignment azimuth direction of the liquid crystal molecules and a second straight line longest among lines dividing the opening in the direction orthogonal to the initial alignment azimuth direction, the sign of the average slope of each of the divided contour portions differs from the signs of the average slopes of two adjacent contour portions, and the average slope of the entire contour of the opening is not zero.

With the longer of the first straight line and the second straight line dividing the opening being defined as an x-axis and the shorter of the first straight line and the second straight line dividing the opening being defined as a y-axis or, with one of the first straight line and the second straight line being defined as the x-axis and the other as the y-axis in the case where the first straight line and the second straight line dividing the opening have the same length, the average slope of each of the contour portions on a first quadrant and a third quadrant may be negative, and the average slope of each of the contour portions on a second quadrant and a fourth quadrant may be positive.

The liquid crystal molecules may have positive anisotropy of dielectric constant.

The relation A>B may hold, where A represents a length of the opening on the first straight line and B represents a length of the opening on the second straight line.

The angle formed between the initial alignment azimuth direction and the longitudinal direction of the opening may be 450 or less in a plan view.

The liquid crystal molecules may have negative anisotropy of dielectric constant.

The relation A<B may hold, where A represents a length of the opening on the first straight line and B represents a length of the opening on the second straight line.

The angle formed between the initial alignment azimuth direction and the longitudinal direction of the opening may be 450 or more in a plan view.

In a voltage applied state in which a voltage is applied between the first electrode and the second electrode, the liquid crystal molecules may rotate in the same azimuth direction in a central portion of the opening.

A shape of the opening may be the same as a 180° rotated shape in a plane parallel to the first substrate.

In at least a white display state, first, second, and third liquid crystal domains may be present on the opening, the first liquid crystal domain may include two domain portions located separately in two of four regions adjacent to each other vertically and horizontally in a plan view and a coupling portion coupling the two domain portions and located in the central portion of the opening, the two regions being the upper right region and the lower left region or the lower right region and the upper left region, and the second and third liquid crystal domains may be located separately in the other two regions where the two domain portions are not located.

### Advantageous Effects of Invention

According to the present invention, in a horizontal alignment mode liquid crystal display device, it is possible to achieve high resolution and to improve the transmittance.

### BRIEF DESCRIPTION OF DRAWINGS

FIG. 1 is a schematic cross-sectional view of a liquid crystal display device according to Embodiment 1, showing an OFF state.

FIG. 2 is a schematic plan view of the liquid crystal display device according to Embodiment 1.

FIG. 3 is a view showing a relationship between the shape of an opening and first and second straight lines in a case of using liquid crystal molecules having positive anisotropy of dielectric constant, with (1) to (5) respectively showing the units of display of liquid crystal display devices used in Examples 1 to 5, and (6) explaining how to calculate the average slope of each contour portion of the opening.

FIG. 4 is a view showing a relationship between the shape of an opening and first and second straight lines in a case of using liquid crystal molecules having negative anisotropy of dielectric constant, with (1) to (5) respectively showing the units of display of liquid crystal display devices used in Examples 1 to 5, and (6) explaining how to calculate the average slope of each contour portion of the opening.

FIG. 5 is a view showing a relationship between the shape of an opening and third and fourth straight lines in a case of using liquid crystal molecules having positive anisotropy of dielectric constant, with (1) to (5) respectively showing the units of display of the liquid crystal display devices used in Examples 1 to 5.

FIG. 6 is a view showing a relationship between the shape of an opening and third and fourth straight lines in a case of using liquid crystal molecules having negative anisotropy of dielectric constant, with (1) to (5) respectively showing the units of display of the liquid crystal display devices used in Examples 1 to 5.

FIG. 7 is a schematic view for explaining alignment control of liquid crystal molecules in the ON state in the liquid crystal display device according to Embodiment 1.

FIG. 8 is a plan view showing the simulation result of the alignment distribution of the liquid crystal molecules in the ON state in the liquid crystal display device according to Embodiment 1.

FIG. 9 is a schematic view showing a case where an opening is formed by a plurality of exposures, with (1) showing the first exposure part, and (2) showing the second exposure part.

FIG. 10 is a view relating to a liquid crystal display device according to Example 1, with (1) being a schematic plan view showing a counter electrode and a pixel electrode, (2) being a plan view showing the simulation result of an alignment distribution of liquid crystal molecules when 5.5 V is applied, and (3) being a plan view showing the simulation result of the alignment distribution of liquid crystal molecules when 6.0 V is applied.

FIG. 11 is a view relating to Example 1, with (1) being a plan view showing one opening in a counter electrode and pixel electrodes, (2) being a view obtained by rotating (1) by 180° in a plane parallel to the first substrate, (3) being a view showing the electric field distribution at the time of voltage application at the opening in (1), and (4) being a view showing the transmittance distribution at the time of voltage application at the opening in (1).

FIG. 12 is a view relating to a liquid crystal display device according to Example 2, with (1) being a schematic plan view of the liquid crystal display device, (2) being a schematic plan view showing a counter electrode and pixel electrodes, and (3) being a plan view showing the simulation result of the alignment distribution of liquid crystal molecules when 6.0 V is applied.

FIG. 13 is a view relating to a liquid crystal display device according to Example 3, with (1) being a schematic plan view of the liquid crystal display device, (2) being a schematic plan view showing a counter electrode and pixel electrodes, and (3) being a plan view showing the simulation result of the alignment distribution of liquid crystal molecules when 6.0 V is applied.

FIG. 14 is a view relating to a liquid crystal display device according to Example 4, with (1) being a schematic plan view of the liquid crystal display device, (2) being a schematic plan view showing a counter electrode and pixel electrodes, and (3) being a plan view showing the simulation result of the alignment distribution of liquid crystal molecules when 6.0 V is applied.

FIG. 15 is a schematic plan view of the liquid crystal display device according to Example 5.

FIG. 16 is a view relating to the liquid crystal display device according to Example 5, with (1) being a schematic plan view showing a counter electrode and pixel electrodes, (2) being a plan view showing the simulation result of an alignment distribution of liquid crystal molecules when 5.5 V is applied, and (3) being a plan view showing the simulation result of the alignment distribution of liquid crystal molecules when 6.0 V is applied.

FIG. 17 is a view showing a relationship between the shape of an opening and a first straight line when liquid crystal molecules having positive anisotropy of dielectric constant are used, with (1) being a view of an opening having a W-shaped contour portion, and (2) being a view of an opening having contour portions parallel to each other.

FIG. 18 is a schematic plan view showing a counter electrode in an FFS mode liquid crystal display device according to Comparative Embodiment 1 studied by the present inventors.

FIG. 19 is a plan view showing the simulation result of the alignment distribution of the liquid crystal molecules in the ON state in the unit of display of the liquid crystal display device using the counter electrode in FIG. 18.

FIG. 20 is a schematic plan view of the liquid crystal display device according to Comparative Example 1.

FIG. 21 is a view relating to a liquid crystal display device according to Comparative Example 1, with (1) being a schematic plan view showing a counter electrode and pixel electrodes, (2) being a plan view showing the simulation result of an alignment distribution of liquid crystal molecules when 4.5 V is applied, (3) being a plan view showing the simulation result of the alignment distribution of liquid crystal molecules when 5.0 V is applied, and (4) being an enlarged plan view of a portion enclosed with a dotted line in (3).

FIG. 22 is a view relating to Comparative Example 1, with (1) being a plan view showing one opening in a counter electrode and pixel electrodes, (2) being a view showing electric field distribution 1 at the time of voltage application at the opening in (1), (3) being a view showing transmittance distribution 1 in the state in (2), (4) being a view showing electric field distribution 2 at the time of voltage application at the opening in (1), and (5) being a view showing transmittance distribution 2 in the state in (4).

### DESCRIPTION OF EMBODIMENTS

Embodiments of the present invention will be described below. The present invention is not limited to the following embodiments, and it is possible to appropriately change the design within the scope in which the configuration of the present invention is satisfied.

In the following description, the same reference numerals denote the same parts or parts having similar functions in different drawings, and a repetitive description thereof is omitted.

The respective configurations described in the embodiments may be appropriately combined or changed within a range not deviating from the gist of the present invention.

### Embodiment 1

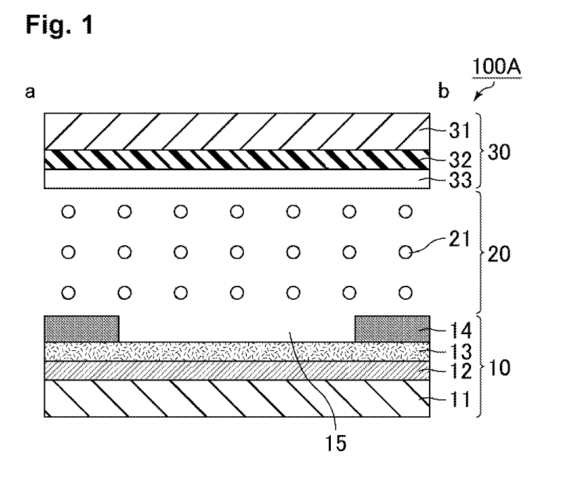

A liquid crystal display device according to Embodiment 1 will be described with reference to FIGS. 1 to 9.

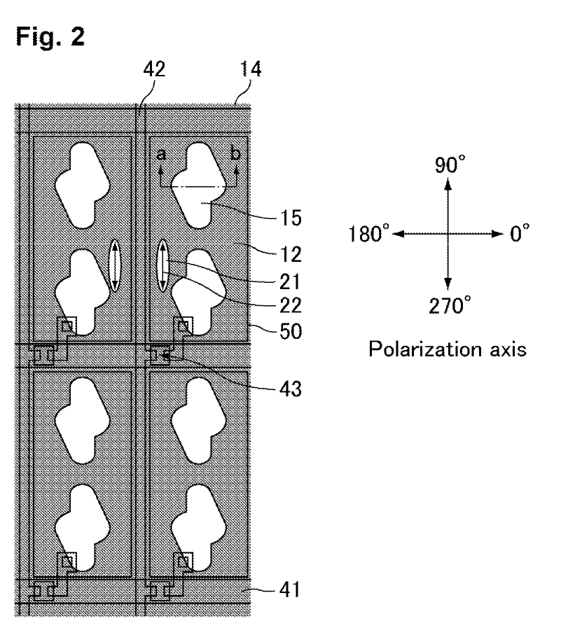

FIG. 1 is a schematic cross-sectional view of the liquid crystal display device according to Embodiment 1, showing an OFF state. FIG. 1 shows a section taken along line a-b shown in FIG. 2.

As shown in FIG. 1, a liquid crystal display device 100A according to Embodiment 1 sequentially includes a first substrate 10, a liquid crystal layer 20 containing liquid crystal molecules 21, and a second substrate 30. The first substrate 10 is a TFT array substrate, and has a structure formed by sequentially stacking a first polarizer (not shown), an insulating substrate (for example, a glass substrate) 11, a pixel electrode (a first electrode) 12, an insulating layer (insulating film) 13, and a counter electrode (second electrode) 14 toward the liquid crystal layer 20. The second substrate 30 is a color filter substrate, and has a structure formed by sequentially stacking a second polarizer (not shown), an insulating substrate (for example, a glass substrate) 31, a color filter 32, and an overcoat layer 33 toward the liquid crystal layer 20. Both the first polarizer and the second polarizer are absorptive polarizers, and have a crossed Nicols configuration relationship with their absorption axes being orthogonal to each other.

The pixel electrode 12 is a planar electrode on which no opening is formed. The pixel electrode 12 and the counter electrode 14 are stacked with the insulating layer 13 being interposed between them, and the pixel electrode 12 exists below an opening 15 provided in the counter electrode 14. When a potential difference is generated between the pixel electrode 12 and the counter electrode 14, a fringe electric field is generated around the opening 15 of the counter electrode 14.

Because the counter electrode 14 supplies a potential common to each unit of display, the counter electrode 14 may be formed on almost the entire surface of the first substrate 10 (excluding the opening portion for forming a fringe electric field). The counter electrode 14 may be electrically connected to the external connection terminal at the outer peripheral portion (frame region) of the first substrate 10.

As the insulating layer 13 provided between the pixel electrode 12 and the counter electrode 14, for example, an organic film (dielectric constant ε=3 to 4), an inorganic film (dielectric constant ε=5 to 7) such as silicon nitride (SiNx), silicon oxide (SiO₂), or a stacked film of them can be used.

The liquid crystal molecules 21 may have negative anisotropy of dielectric constant (Δε) defined by the following formula, which may have a negative or positive value. That is, the liquid crystal molecules 21 may have negative anisotropy of dielectric constant or positive anisotropy of dielectric constant. The liquid crystal material including the liquid crystal molecules 21 having negative anisotropy of dielectric constant tends to have a relatively high viscosity. Thus, from the viewpoint of obtaining high-speed response performance, a liquid crystal material containing the liquid crystal molecules 21 having positive anisotropy of dielectric constant is preferable. However, even with a liquid crystal material having negative anisotropy of dielectric constant, because it has a viscosity as low as that of a liquid crystal material having positive anisotropy of dielectric constant, the same high speed response performance can be obtained by the means of this embodiment.

Δε=(dielectric constant in major axis direction)−(dielectric constant in minor axis direction)

The alignment of liquid crystal molecules 21 in a voltage non-applied state (to be also simply referred to as “no voltage applied state” or “OFF state” hereinafter) in which no voltage is applied between the pixel electrode 12 and the counter electrode 14, that is, the first electrode and the second electrode, is controlled to be parallel to the first substrate 10. Being “parallel” includes not only being perfectly parallel but also being regarded as parallel (substantially parallel) in this technical field. The pre-tilt angle (tilt angle in the OFF state) of the liquid crystal molecules 21 is preferably less than 3° with respect to the surface of the first substrate 10, more preferably less than 1°.

In a voltage applied state (to be also simply referred to as “voltage applied state” or “ON state” hereinafter) in which a voltage is applied between the pixel electrode 12 and the counter electrode 14, that is, between the first electrode and the second electrode, a voltage is applied to the liquid crystal layer 20, and the alignment of liquid crystal molecules 21 is controlled by the multilayer structure constituted by the pixel electrode 12, the insulating layer 13, and the counter electrode 14 which are provided on the first substrate 10. In this case, the pixel electrode 12 is an electrode provided for each unit of display, and the counter electrode 14 is an electrode shared by a plurality of units of display. Note that “unit of display” means a region corresponding to one pixel electrode 12 and may be referred to as a “pixel” in the technical field of liquid crystal display devices. When one pixel is divisionally driven, each element may be referred to as a “sub-pixel”, “dot”, or “picture element”.

The second substrate 30 is not particularly limited, and a color filter substrate generally used in the field of liquid crystal display devices can be used. The overcoat layer 33 flattens the surface of the second substrate 30 which is located on the liquid crystal layer 20 side, and for example, an organic film (dielectric constant ε=3 to 4) can be used.

Usually, the first substrate 10 and the second substrate 30 are bonded together by a sealant provided so as to surround the periphery of the liquid crystal layer 20, and the first substrate 10, the second substrate 30, and the sealing material hold the liquid crystal layer 20 in a predetermined region. As a sealant, for example, an epoxy resin containing an inorganic filler or an organic filler and a hardening agent can be used.

In addition to the first substrate 10, the liquid crystal layer 20, and the second substrate 30, the liquid crystal display device 100A may include a backlight, an optical film such as a retardation film, a viewing angle expansion film, or a brightness enhancement film, an external circuit such as a tape carrier package (TCP) or a printed circuit board (PCB), and a member such as a bezel (frame). These members are not particularly limited, and because those commonly used in the field of liquid crystal display devices can be used, descriptions of them will be omitted.

The alignment mode of the liquid crystal display device 100A is a fringe field switching (FFS) mode.

Although not shown in FIG. 1, a horizontal alignment film is usually provided on the surface of the first substrate 10 and/or the second substrate 30 which is located on the liquid crystal layer 20 side. The horizontal alignment film has a function of aligning the liquid crystal molecules 21 existing near the film in parallel to the film surface. Furthermore, the horizontal alignment film can align the major axis directions of the liquid crystal molecules 21, aligned parallel to the first substrate 10, in a specific in-plane azimuth direction. It is preferable that the horizontal alignment film has been subjected to alignment treatment such as photo alignment treatment and rubbing treatment. The horizontal alignment film may be a film made of an inorganic material or a film made of an organic material.

The positions of the counter electrode 14 and the pixel electrode 12 may be interchanged. That is, in the multilayer structure shown in FIG. 1, the counter electrode 14 is adjacent to the liquid crystal layer 20 through a horizontal alignment film (not shown), but the pixel electrode 12 may be provided adjacent to the layer 20 through a horizontal alignment film (not shown). In this case, the opening 15 is formed in the pixel electrode 12 instead of the counter electrode 14. In addition, the counter electrode 14 corresponds to the first electrode, and the pixel electrode 12 corresponds to the second electrode.

FIG. 2 is a schematic plan view of the liquid crystal display device according to Embodiment 1. As shown in FIG. 2, in a plan view, each opening 15 is formed so as to overlap the corresponding pixel electrode 12, and is shaped such that the average slope of the contour satisfies a specific condition described later. These openings 15 are used to form a fringe electric field (oblique electric field). Because such an opening 15 does not include a complicated shape, it can be applied to an ultrahigh resolution pixel of, for example, 800 ppi or more with no particular problem. The opening 15 is preferably arranged for each unit of display 50, and is preferably arranged with respect to all units of display 50. The planar shape of each unit of display 50 is not particularly limited, and can include a rectangle, a square, and a V shape.

In a plan view, the initial alignment azimuth direction 22 of the liquid crystal molecules 21 is parallel to the polarization axis of one of the first polarizer and the second polarizer, and is perpendicular to the other polarization axis. Therefore, the control method of the liquid crystal display device 100A is a so-called normally black mode in which black display is performed in a voltage non-applied state where no voltage is applied to the liquid crystal layer 20.

In this specification, the initial alignment azimuth direction of liquid crystal molecules means the alignment azimuth direction of liquid crystal molecules in a voltage non-applied state in which no voltage is applied between the first electrode and the second electrode, that is, between the pixel electrode and the counter electrode. The alignment azimuth direction of liquid crystal molecules means the major-axis direction of the liquid crystal molecules.

Although FIG. 2 shows a case where the liquid crystal molecules 21 have positive anisotropy of dielectric constant, the initial alignment azimuth direction 22 of the liquid crystal molecules 21 having negative anisotropy of dielectric constant is rotated by 90° with respect to the initial alignment azimuth direction 22 of the liquid crystal molecules 21 having positive anisotropy of dielectric constant.

As shown in FIG. 2, the drain of a TFT 43 is electrically connected to each pixel electrode 12. A gate signal line (scanning conductive line) 41 is electrically connected to the gate of the TFT 43, and a source signal line (signal conductive line) 42 is electrically connected to the source of the TFT 43. Accordingly, ON/OFF control of the TFT 43 is performed in accordance with the scanning signal input to the gate signal line 41. Then, when the TFT 43 is on, the data signal (source voltage) input to the source signal line 42 is supplied to the pixel electrode 12 via the TFT 43. In this way, in the voltage applied state, a source voltage is applied to the pixel electrode 12 on the lower layer via the TFT 43, and a fringe electric field is generated between the counter electrode 14 and the pixel electrode 12 formed on the upper layer via the insulating film 13. As the TFT 43, a transistor having a channel formed with indium-gallium-zinc-oxygen (IGZO) which is an oxide semiconductor is suitably used.

As shown in FIG. 2, it is preferable that the openings 15 of the counter electrode 14 are arranged side by side in the row direction and/or the column direction between adjacent units of display 50. This makes it possible to stabilize the alignment of the liquid crystal molecules 21 in the voltage applied state. Assume that in the adjacent units of display 50, the openings 15 are alternately arranged in a staggered lattice pattern in the row direction or the column direction as in the case where in a certain unit of display 50, the openings 15 are formed on one side in the longitudinal direction of the unit of display 50, while in the adjacent unit of display 50, the openings 15 are formed on the other side in the longitudinal direction. In this case, the alignment of the liquid crystal molecules 21 becomes unstable and the response speed decreases sometimes.

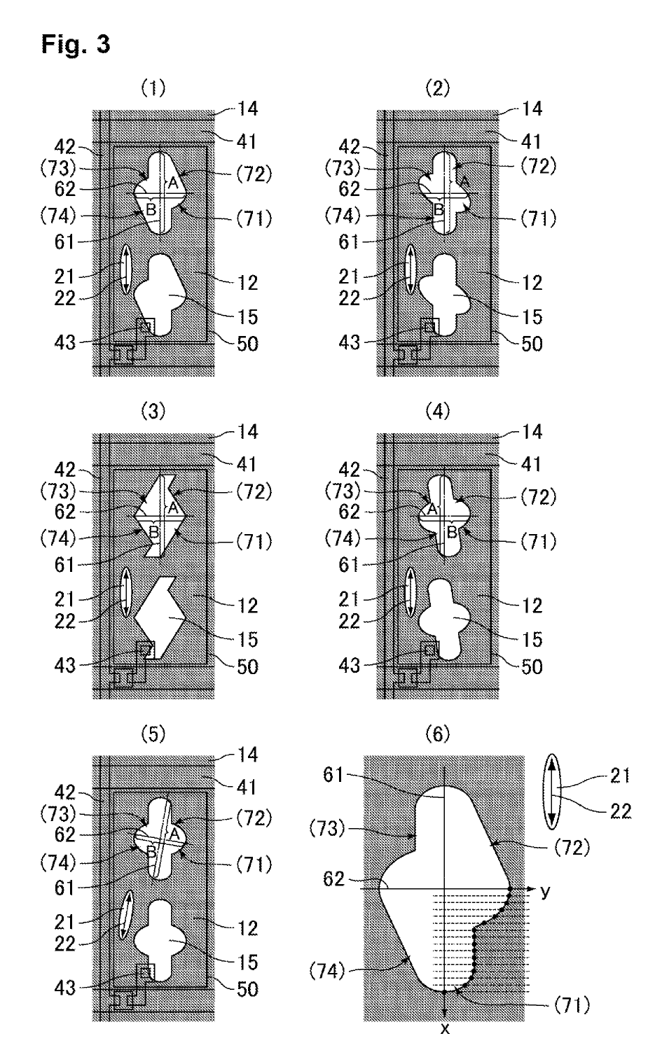

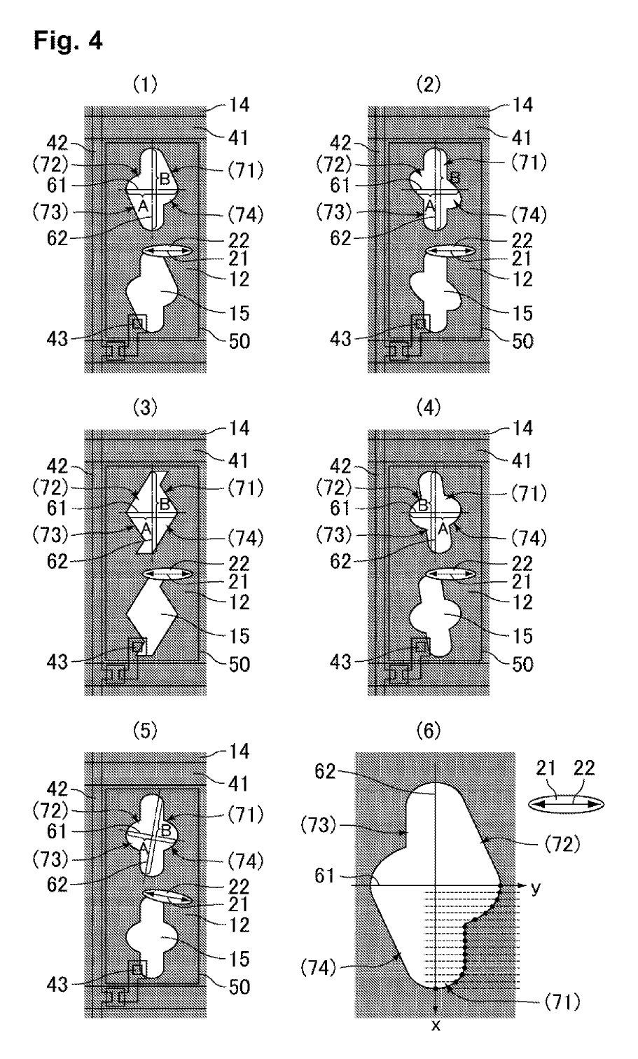

The shape of the opening 15 will be described with reference to FIGS. 3 and 4. FIGS. 3 and 4 are views respectively showing relationships between the shapes of openings and first and second straight lines in cases of using liquid crystal molecules having positive anisotropy of dielectric constant and using liquid crystal molecules having negative anisotropy of dielectric constant, with (1) to (5) respectively showing the units of display of liquid crystal display devices used in Examples 1 to 5, and (6) explaining how to calculate the average slope of each contour portion of the opening.

The shape of the opening 15 satisfies the following condition. When the contour of the opening 15 is divided into four by a first straight line 61 parallel to the initial alignment azimuth direction 22 of the liquid crystal molecules 21 and having the longest length dividing the opening 15 and a second straight line 62 orthogonal to the initial alignment azimuth direction 22 of the liquid crystal molecules 21 and having the longest length dividing the opening 15, (condition 1) the sign of the average slope of each of the divided contour portions differs from the signs of the average slopes of two adjacent contour portions, and (condition 2) the average slope of the entire contour of the opening 15 is not zero.

In this specification, the average slope of each of the divided contour portions is obtained as follows.

As shown in FIGS. 3(6) and 4(6), when the liquid crystal molecules 21 having positive anisotropy of dielectric constant are used, the first straight line 61 is defined as the x-axis, the second straight line 62 is defined as the y-axis, whereas when the liquid crystal molecules 21 having the negative anisotropy of dielectric constant are used, the second straight line 62 is defined as the x-axis, and the first straight line 61 is defined as the y-axis, and n straight lines parallel to the y-axis are drawn, which equally divide the length of the contour portion projected on the x-axis into (n−1) portions. The slope at each of the intersection points between these straight lines and the contour portion (when there are a plurality of intersection points on one straight line, all intersection points) is obtained by differentiation at each point. The value obtained by dividing the sum of the slopes by the total number of intersection points is taken as the average slope of each of the divided contour portion. In this specification, the average slope of the entire contour is obtained by dividing the sum of the average slopes of the divided four contour portions by 4.

However, the point where the slope becomes 0 or infinite does not contribute to alignment control and hence is excluded. Assume that the n straight lines parallel to the y-axis include a straight line on the y-axis and a straight line passing through a point farthest from the y-axis of the contour portion. The positive and negative directions of the x-axis and the y-axis can be arbitrarily determined with the intersection point between the x-axis and the y-axis being the origin. Furthermore, when the lengths of the first straight line 61 and the second straight line 62 that divide the opening 15 are equal to each other, either one of the first straight line 61 and the second straight line 62 may be set as the x-axis, and the other may be set as the y-axis regardless of whether the anisotropy of dielectric constant of the liquid crystal molecules 21 is positive or negative.

Although n is an arbitrary positive integer and ideally infinite, n is preferably an integer of 100 to 300, preferably an integer of 200 to 300. Further, condition 1 and condition 2 described above may be satisfied for all n in these numerical ranges.

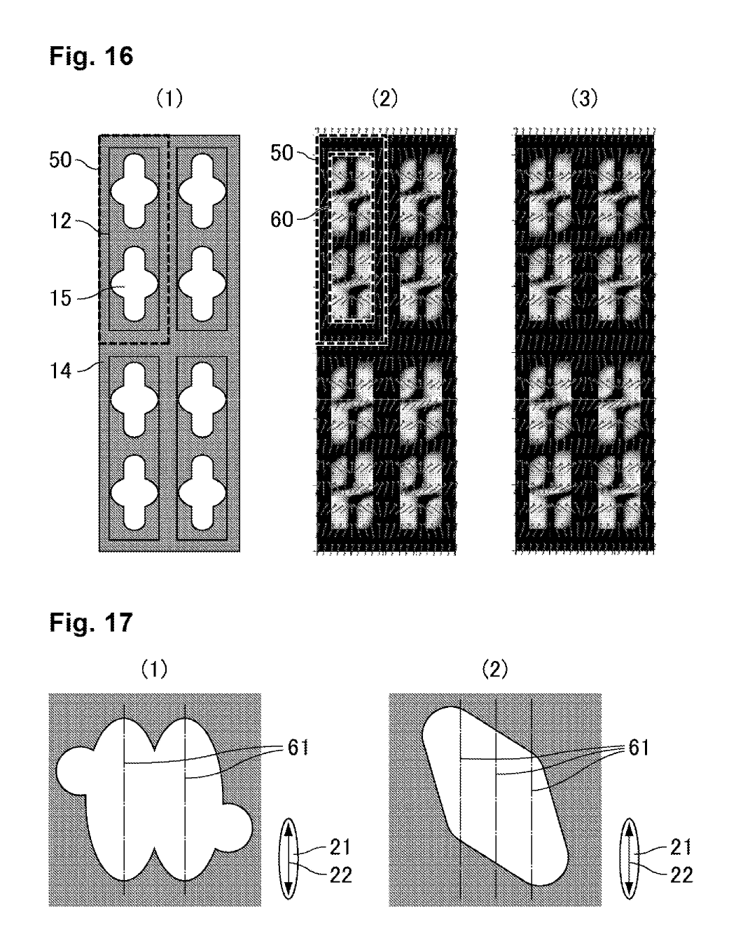

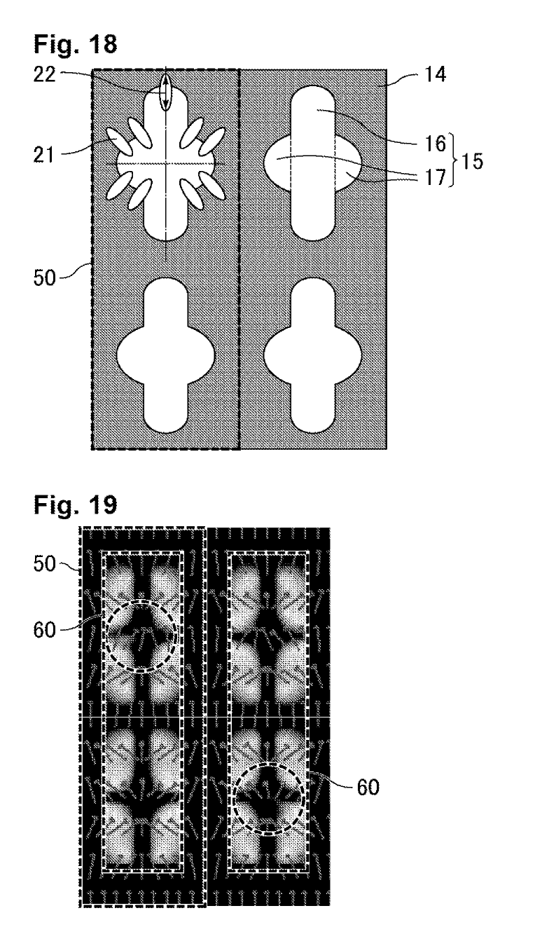

FIG. 17 is a view showing a relationship between the shape of an opening and a first straight line when liquid crystal molecules having positive anisotropy of dielectric constant are used, with (1) being a view of an opening having a W-shaped contour portion, and (2) being a view of an opening having contour portions parallel to each other. A plurality of first straight lines 61 and/or a plurality of second straight lines 62 may exist with respect to one opening 15. Assume that in this case, for all the combinations of the first straight lines 61 and the second straight lines 62, condition 1 and condition 2 are satisfied. Specific examples of such a case includes cases where, for example, the openings 15 having shapes as shown in FIGS. 17(1) and 17(2) are provided. As shown in FIG. 17(2), when the opposing portions of the opening 15 where the first straight lines 61 can be arranged are parallel to each other and not perpendicular or parallel to the initial alignment azimuth direction 22, conditions 1 and 2 are satisfied for all combinations of at least three first straight lines 61 passing through both ends and the center of the portion and the second straight line 62. The same applies to the case where the opposing portions of the opening 15 in which the second straight lines 62 can be arranged are parallel to each other and not perpendicular or parallel to the initial alignment azimuth direction 22.

When the sign of the average slope of each of the contour portions differs from the signs of the average slopes of two adjacent contour portions (condition 1), it is possible to generate an electric field for rotating the liquid crystal molecules 21 in the opposite azimuth direction in adjacent contour portions and form bend-shaped and splay-shaped liquid crystal alignments within a narrow region. When the average slope of the entire contour of the opening 15 is not zero (condition 2), the shape of the opening 15 is asymmetric with respect to the initial alignment azimuth direction 22 of the liquid crystal molecules 21, and the rotation of the liquid crystal molecules 21 in the central portion of the opening 15 can be determined in one direction. This makes it possible to reduce the occurrence of a phenomenon in which the alignment state of the liquid crystal molecules 21 differs depending on the unit of display 50 at the time of applying a high voltage and to stabilize the alignment of the liquid crystal molecules 21 even when a high voltage is applied in all units of display 50. Therefore, a sufficiently high voltage can be applied and the transmittance can be improved.

The absolute value of the average slope of each of the contour portions is preferably 0.01 to 2, more preferably 0.05 to 1.8, and even more preferably 0.1 to 1.5.

The absolute value of the average slope of the entire contour of the opening 15 is preferably 0.01 to 2, more preferably 0.02 to 1.5, and even more preferably 0.05 to 1. When the average slope of the entire contour of the opening 15 is within the above range, the balance of the liquid crystal domains generated at the time of voltage application can be effectively maintained, so that the alignment stability of the liquid crystal molecules 21 can be further enhanced. Therefore, it is possible to further improve the response speed.

When one of the first straight line 61 and the second straight line 62 which has a longer length dividing the opening 15 is defined as the x-axis and one of the first straight line 61 and the second straight line 62 which has a shorter length dividing the opening 15 is defined as the y-axis, or when the first straight line 61 and the second straight line 62 have the same length dividing the opening 15, one of the first straight line 61 and the second straight line 62 is defined as the x-axis and the other is defined as the y-axis. In this case, the contour of the opening 15 is divided into four contour portions on a first quadrant 71 to a fourth quadrant 74. Note that the positive and negative directions of the x-axis and the y-axis can be arbitrarily determined with the intersection point between the x-axis and the y-axis being the origin, and the region where x>0 and y>0 is the first quadrant 71, the region where x<0 and y>0 is the second quadrant 72, the region where x<0 and y<0 is the third quadrant 73, the region where x>0 and y<0 is the fourth quadrant 74.

The average slopes of the respective contour portions on the first quadrant 71 and the third quadrant 73 are preferably negative and the average slopes of the respective contour portions on the second quadrant 72 and the fourth quadrant 74 are preferably positive. This can further simplify the shape of the opening 15, and hence can achieve higher resolution.

Letting A be the length of the opening 15 on the first straight line 61 and B be the length of the opening 15 on the second straight line 62, when A>B, liquid crystal molecules 21 having positive anisotropy of dielectric constant are preferably used. The liquid crystal molecules 21 having positive anisotropy of dielectric constant rotate so as to be orthogonal to the slope of the contour of the opening 15 when a voltage is applied. The angle formed between the azimuth direction orthogonal to the slope of the contour of the opening 15 and the initial alignment azimuth direction 22 of the liquid crystal molecules 21 having positive anisotropy of dielectric constant is larger when A>B than when A<B. Therefore, in the case of A>B, the liquid crystal molecules 21 having positive anisotropy of dielectric constant at the time of voltage application can be more rotated from the initial alignment azimuth direction 22, and the transmittance and the alignment stability can be further improved.

On the other hand, when A<B, it is preferable to use liquid crystal molecules 21 having negative anisotropy of dielectric constant. The liquid crystal molecules 21 having negative anisotropy of dielectric constant rotate so as to become parallel to the slope of the contour of the opening 15 at the time of voltage application. The angle formed between the azimuth direction parallel to the slope of the contour of the opening 15 and the initial alignment azimuth direction 22 of the liquid crystal molecules 21 having negative anisotropy of dielectric constant is larger when A<B than when A>B. Therefore, in the case of A<B, the liquid crystal molecules 21 having negative anisotropy of dielectric constant at the time of voltage application can be more rotated from the initial alignment azimuth direction 22, and the transmittance and the alignment stability can be further improved.

The length A of the opening 15 on the first straight line 61 is the length of the divided portion of the opening 15 divided by the first straight line 61 and the length B of the opening 15 on the second straight line 62 is the length of the divided portion of the opening 15 divided by the second straight line 62.

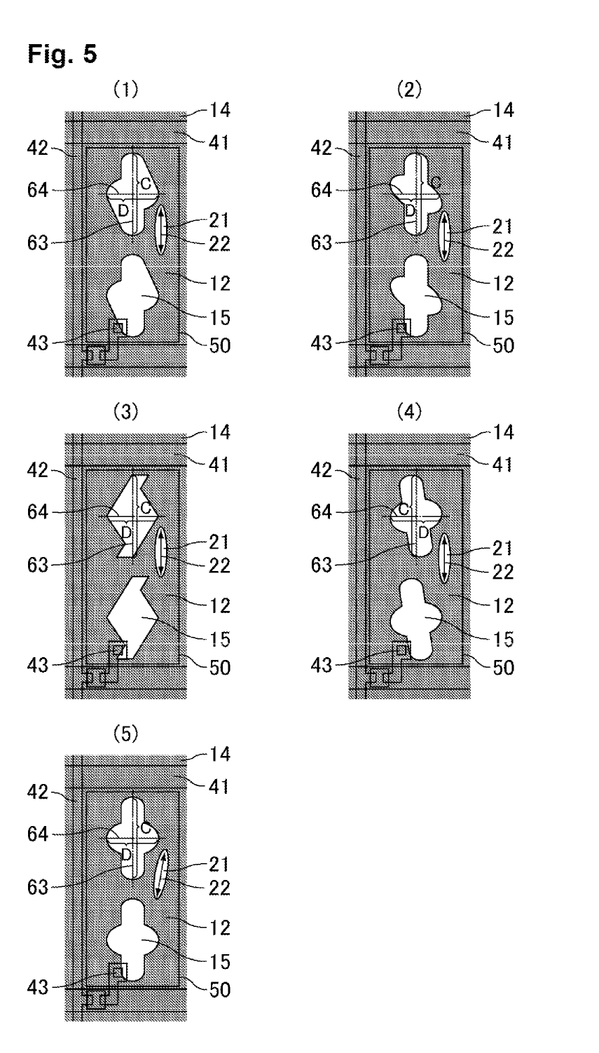

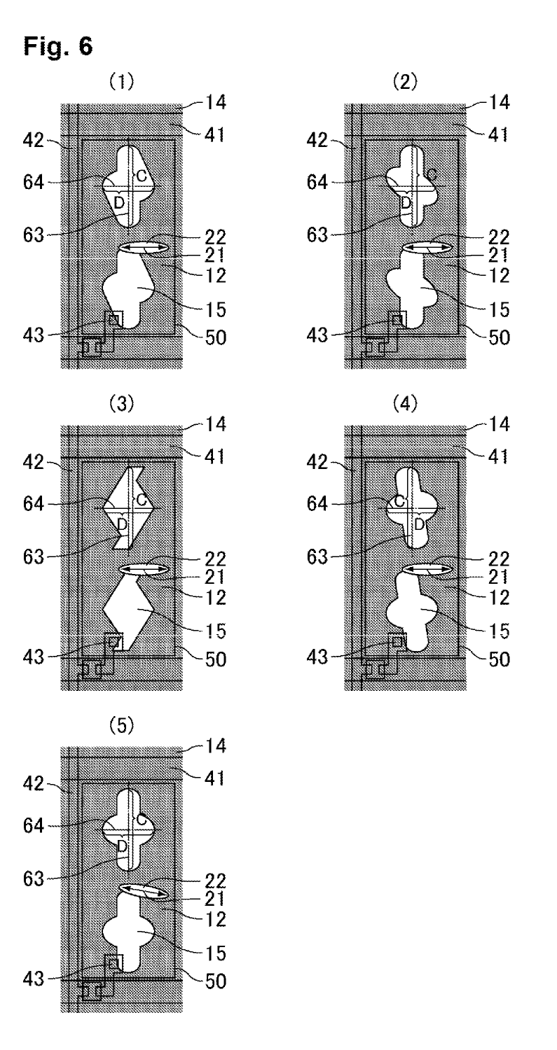

A preferable relationship between the longitudinal direction of the opening 15 and the initial alignment azimuth direction 22 of the liquid crystal molecules 21 will be described next with reference to FIGS. 5 and 6. FIGS. 5 and 6 are views respectively showing relationships between the shape of an opening and third and fourth straight lines in cases of using liquid crystal molecules having positive anisotropy of dielectric constant and liquid crystal molecules having negative anisotropy of dielectric constant, with (1) to (5) respectively showing the units of display of the liquid crystal display devices used in Examples 1 to 5.

A method of determining the longitudinal direction of the opening 15 will be described first. Let C be the length of the opening 15 divided by a third straight line 63 parallel to the straight line portion of the source signal line 42 (signal conductive line) and having the longest length dividing the opening 15 and D be the length of the opening 15 divided by a fourth straight line 64 parallel to the straight line portion of the gate signal line 41 (scanning conductive line) and having the longest length dividing the opening 15. In this case, the direction of the third straight line 63 or the fourth straight line 64 corresponding to the longer one of C and D is the longitudinal direction of the opening 15. Therefore, in either of the examples shown in FIGS. 5 and 6, the third straight line 63 corresponds to the longitudinal direction of the opening 15. When there are a plurality of third straight lines 63 and/or a plurality of fourth straight lines 64, the lengths of the opening 15 divided by all the straight lines are compared with each other to determine the longitudinal direction of the opening 15.

When the liquid crystal molecules 21 have positive anisotropy of dielectric constant, it is preferable that the angle formed between the initial alignment azimuth direction 22 of the liquid crystal molecules 21 and the longitudinal direction of the opening 15 is 45° or less in a plan view. This can satisfy A>B, and hence rotate the liquid crystal molecules 21 having positive anisotropy of dielectric constant more greatly from the initial alignment azimuth direction 22 at the time of voltage application, so that the transmittance and the alignment stability can be further improved.

When the liquid crystal molecules 21 have negative anisotropy of dielectric constant, it is preferable that the angle formed between the initial alignment azimuth direction 22 of the liquid crystal molecules 21 and the longitudinal direction of the opening 15 is 45° or more in a plan view. This makes it possible to satisfy A<B, and hence to rotate the liquid crystal molecules 21 having negative anisotropy of dielectric constant more greatly from the initial alignment azimuth direction 22 at the time of voltage application, so that the transmittance and the alignment stability can be further improved.

When the angle formed between the initial alignment azimuth direction 22 of the liquid crystal molecules 21 and the longitudinal direction of the opening 15 is 45°, the same effect can be obtained regardless of whether liquid crystal molecules having positive or negative anisotropy of dielectric constant are used.

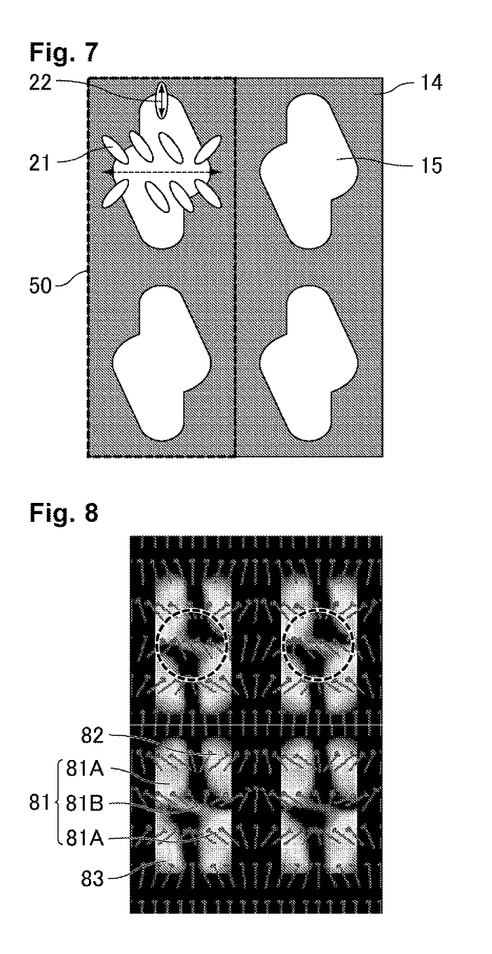

FIG. 7 is a schematic view for explaining alignment control of liquid crystal molecules in the ON state in the liquid crystal display device according to Embodiment 1. FIG. 8 is a plan view showing the simulation result of the alignment distribution of the liquid crystal molecules in the ON state in the liquid crystal display device according to Embodiment 1.

According to this embodiment, because the shape of the opening 15 is asymmetrical with respect to the initial alignment azimuth direction 22 of the liquid crystal molecules 21, the liquid crystal molecules 21 rotate in the same azimuth direction in the central portion of the opening 15 in the voltage applied state, as shown in FIGS. 7 and 8. This can more reliably reduce the occurrence of a phenomenon in which the alignment state of the liquid crystal molecules 21 differs depending on the unit of display 50 at the time of applying a high voltage. The rotation in the same azimuth direction means that the liquid crystal molecules 21 rotate to the same side with respect to the initial alignment azimuth direction 22.

The shape of the opening 15 is preferably the same as the 180° rotated shape in a plane parallel to the first substrate 10. Using the opening 15 having such a shape can implement a desired alignment more efficiently. In this case, that the shape of the opening 15 is the same as the 180° rotated shape means that the shape when it is rotated by 180° remains substantially the same, and the shape of the opening 15 overlaps 75% or more of the shape when it is rotated by 180° in a plane parallel to the first substrate 10.

In at least the white (highest gray scale) display state, as shown in FIG. 8, first, second, and third liquid crystal domains 81 to 83 are present on the opening 15, and the first liquid crystal domain 81 includes two domain portions 81A located separately in two of four regions adjacent to each other vertically and horizontally in a plan view and a coupling portion 81B coupling the two domain portions and located in the central portion of the opening, the two regions being the upper right region and the lower left region or the lower right region and the upper left region, and the second and third liquid crystal domains 82 and 83 are located separately in the other two regions where the two domain portions 81A are not located.

That is, in at least the white display state, as shown in FIGS. 7 and 8, the first liquid crystal domain 81, the second liquid crystal domain 82, and the third liquid crystal domain 83 have occurred on the opening (not shown in FIG. 8) 15. In a plan view, the first liquid crystal domain 81 includes two domain portions 81A located in two of the four regions adjacent to each other vertically and horizontally. The two regions are the lower right region and the upper left region. A coupling portion 81B coupling the two domain portions 81A is located in the central portion of the opening 15. The second liquid crystal domain 82 and the third liquid crystal domain 83 are located separately in two regions where the two domain portions 81A are not located.

This makes it possible to reliably regulate the alignment of the liquid crystal molecules in the coupling portion 81B positioned in the central portion of the opening 15 by the alignment of the liquid crystal molecules in the two domain portions 81A. That is, this can more reliably reduce the occurrence of a phenomenon in which the alignment state of the liquid crystal molecules 21 differs depending on the unit of display 50 at the time of applying a high voltage. Note that the two domain portions 81A may be located separately in two of the four regions adjacent to each other vertically and horizontally, and the two regions are the upper right region and the lower left region in a plan view. Although the first liquid crystal domain 81, the second liquid crystal domain 82, and the third liquid crystal domain 83 may occur at least in the white display state, they may occur in a high gray scale (for example, a gray scale of 240 or more and 256 or less when the number of gray scale levels of each unit of display 50 is 256) display state in which a high voltage (for example, 5.0 V or more) is applied between the pixel electrode 12 and the counter electrode 14, that is, between the first electrode and the second electrode.

The relationship between the first to third liquid crystal domains 81 to 83 and the initial alignment azimuth direction 22 of the liquid crystal molecules 21 will be studied. As the angle of the initial alignment azimuth direction 22 of the liquid crystal molecules 21 is increased toward the direction in which the liquid crystal molecules 21 forming the first liquid crystal domain 81 rotate, the regions of the second liquid crystal domain 82 and the third liquid crystal domain 83 decrease at the time of voltage application, and the balance between the liquid crystal domains is lost. As a result, distortion caused by bend-shaped or splay-shaped liquid crystal alignments becomes small, so that the effect of high-speed response decreases. As the angle of the initial alignment azimuth direction 22 of the liquid crystal molecules 21 is increased toward the azimuth direction in which the liquid crystal molecules 21 forming the second liquid crystal domain 82 and the third liquid crystal domain 83 rotate, the probability that the coupling portion 81B does not occur in the first liquid crystal domain 81 may increase. In this case, the alignment stability deteriorates.

Accordingly, in order to improve the response speed and further enhance the alignment stability, the angle formed between the initial alignment azimuth direction 22 of the liquid crystal molecules 21 having positive anisotropy of dielectric constant and the longitudinal direction of the opening 15 is preferably smaller than 30°, and more preferably smaller than 20°.

From the same point of view, the angle formed between the initial alignment azimuth direction 22 of the liquid crystal molecules 21 having negative anisotropy of dielectric constant and the longitudinal direction of the opening 15 is preferably larger than 60°, and more preferably larger than 70°.

In the case where the liquid crystal molecules 21 have positive anisotropy of dielectric constant, the lower limit of the angle formed between the initial alignment azimuth direction 22 of the liquid crystal molecules 21 and the longitudinal direction of the opening 15 is not particularly limited, and is only required to be 0° or more. In the case where the liquid crystal molecules 21 have negative anisotropy of dielectric constant, the upper limit of the angle formed between the initial alignment azimuth direction 22 of the liquid crystal molecules 21 and the longitudinal direction of the opening 15 is not particularly limited, and is only required to be 90° or less.

In this specification, a liquid crystal domain means a region defined by a boundary (dark line) at which the liquid crystal molecules 21 do not rotate from the initial alignment azimuth direction 22 at the time of voltage application, and the liquid crystal molecules 21 rotate in the opposite azimuth direction in the liquid crystal domains in the upper and lower or right and left regions of the four regions adjacent to each other vertically and horizontally. Further, in this specification, “vertically and horizontally” refer to the relative positional relationship of four targets (units of display, regions, and the like), and do not mean any absolute direction.

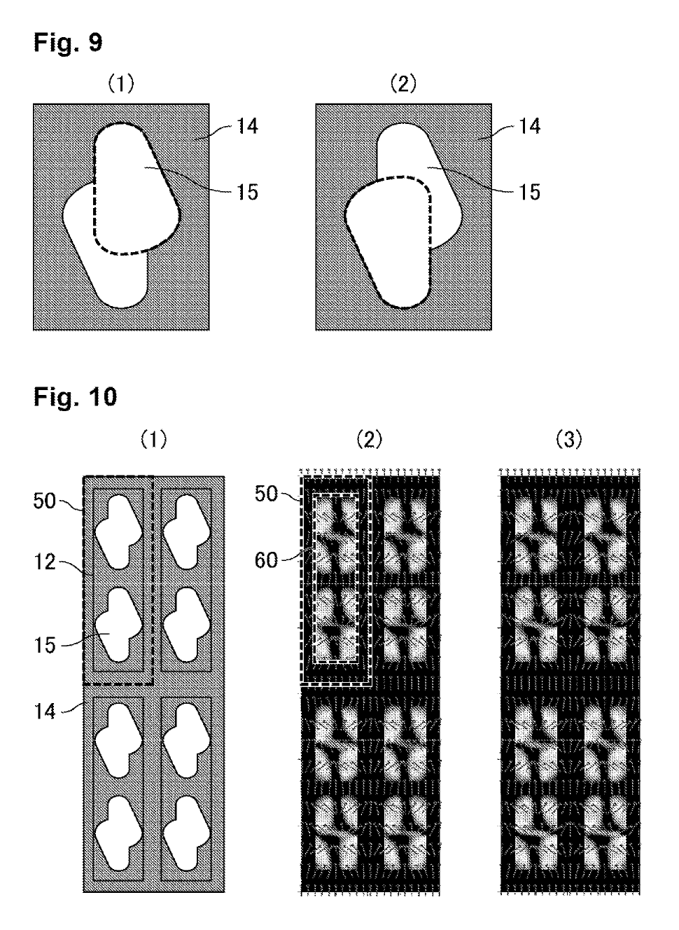

FIG. 9 is a schematic view showing a case where an opening is formed by a plurality of exposures, with (1) showing the first exposure part, and (2) showing the second exposure part. When the opening 15 is to be formed in the counter electrode 14, means such as exposure can be used. In the case where the opening 15 having an asymmetrical shape as shown in FIG. 7 is to be formed by a stepper or the like, if the opening 15 is formed by a single exposure, end portions and the like may be blunted and a desired shape may not be obtained. In such a case, for example, as shown in FIG. 9, a desired shape can be formed by a plurality of exposures.

The operation of the liquid crystal display device 100A will be described below.

No electric field is formed in the liquid crystal layer 20 in the OFF state, and the liquid crystal molecules 21 are aligned parallel to the first substrate 10. Because the alignment azimuth direction of the liquid crystal molecules 21 is parallel to the absorption axis of one of the first polarizer and the second polarizer and the first polarizer and the second polarizer are in a crossed Nicols configuration relationship, the liquid crystal display device 100A in the OFF state transmits no light and performs black display.

In the ON state, an electric field corresponding to the magnitude of the voltage between the pixel electrode 12 and the counter electrode 14 is formed in the liquid crystal layer 20. Specifically, because the opening 15 is formed in the counter electrode 14 provided closer to the liquid crystal layer 20 than the pixel electrode 12, a fringe electric field is generated around the opening 15. The liquid crystal molecules 21 rotate under the influence of the electric field, and change the alignment azimuth direction from the alignment azimuth direction in the OFF state to the alignment azimuth direction in the ON state (see FIG. 7). As a result, the liquid crystal display device 100A in the ON state transmits light and performs white display.

Although an embodiment of the present invention has been described above, all the matters described can be applied to all the aspects of the present invention.

The present invention will be described in more detail with reference to examples and comparative examples, but the present invention is not limited to only these examples.

### Example 1

A liquid crystal display device 100A according to Example 1 is a specific example of the liquid crystal display device 100A according to Embodiment 1 described above and has the following configuration.

A pixel pitch in the liquid crystal display device 100A was 10.5 μm×31.5 μm (806 ppi), and a plate-shaped pixel electrode 12 having no punched portion such as an opening was provided on the insulating substrate 11 in each unit of display 50. In addition, the counter electrode 14 having the openings 15 shown in FIGS. 2, 3(1), and 5(1) was provided via an insulating film 13 with dielectric constant ε=6.9. In Example 1, two openings 15 are provided per unit of display, but it is not always necessary to provide two openings 15.

A liquid crystal layer 20 was provided on the counter electrode 14 through an alignment film (not shown). The refractive index anisotropy (Δn) of the liquid crystal layer 20 was set to 0.111, and the in-plane retardation (Re) was set to 330 nm. The viscosity and anisotropy of dielectric constant (Δε) of the liquid crystal molecules 21 used for the liquid crystal layer 20 were respectively set to 70 cps and 7 (positive type).

In a voltage non-applied state, the liquid crystal molecules 21 were set in horizontal alignment so as to be aligned parallel to a first substrate 10, and an initial alignment azimuth direction 22 of the liquid crystal molecules 21 was set to be parallel, in a plan view, to straight lines having angles of 90° and 270° with respect to the polarization axis shown in FIG. 2. The polarizing plate was in a so-called normally black mode in which black display was performed in a voltage non-applied state.

The average slope of each of the contour portions of the opening 15 used in Example 1 was obtained as follows.

First, the contour of the opening 15 was divided into four contour portions by a first straight line 61 and a second straight line 62. In this case, because the liquid crystal molecules 21 used in Example 1 had positive anisotropy of dielectric constant, the first straight line 61 was defined as the x-axis, and the second straight line 62 was defined as the y-axis. Then, the first contour portion located on a first quadrant 71 was projected on the x-axis, and 221 (=n) straight lines parallel to the y-axis were drawn, which equally divided the length of the first contour portion by 220 (=n−1). That is, 221 (=n) straight lines parallel to the y-axis were drawn, which equally divided the width of the first contour portion in the x-axis direction by 220 (=n−1). At this time, a straight line was drawn on the y-axis, and a straight line parallel to the y-axis was also drawn on the point farthest from the y-axis of the first contour portion. Then, the slope at each intersection point was obtained by differentiating at the intersection points between all of these straight lines and the first contour portion (when there are a plurality of intersection points on one straight line, all intersection points). The value obtained by dividing the sum of the slopes by the total number of intersection points was taken as the average slope of the first contour portion. Note that the point where the slope became 0 or infinite did not contribute to alignment control and hence was excluded. The average slopes of the second, third, and fourth contour portions respectively located on a second quadrant 72 to a fourth quadrant 74 were calculated in the same manner as for the first contour portion. In addition, the sum of the average slopes of the first, second, third and fourth contour portions was divided by 4 to obtain the average slope of the entire contour.

Table 1 below shows the average slopes of the contour portions of the opening 15 used in Example 1 and the average slope of the entire contour.

TABLE 1

| | | | | | Average |
|---|---|---|---|---|---|
| | Average slopes of contour portions | | | | slope of |
| | On first | On second | On third | On fourth | entire |
| | quadrant | quadrant | quadrant | quadrant | contour |
| Example 1 | −0.87 | 0.63 | −0.87 | 0.63 | −0.12 |

Table 1 shows that the average slopes of the first and third contour portions on the first quadrant 71 and the third quadrant 73 had negative signs, the average slopes of the second and fourth contour portions on the second quadrant 72 and the fourth quadrant 74 had positive signs, and the sign of the average slope of each contour portion differed from the sign of the average slope of each of the two adjacent contour portions. In addition, the average slope of the entire contour was not zero.

FIG. 3(1) shows the relationship between the shape of the opening 15 used in Example 1 and the lengths A and B. FIG. 5 (1) shows the relationship between the shape of the opening 15 used in Example 1 and the lengths C and D. Table 2 given below shows the lengths A to D and the angle formed between the initial alignment azimuth direction 22 of the liquid crystal molecules 21 and the longitudinal direction of the opening 15.

TABLE 2

| | | | | | Angle formed between initial |
|---|---|---|---|---|---|
| | | | | | alignment azimuth direction |
| | | | | | and longitudinal direction of |
| | A | B | C | D | opening |
| Example 1 | 11 | 7.5 | 11 | 7.5 | 0° |

Table 2 shows that the opening 15 used in Example 1 satisfied A>B and C>D, and the longitudinal direction of the opening 15 was a direction parallel to a third straight line 63. The angle formed between the initial alignment azimuth direction 22 of the liquid crystal molecules 21 and the longitudinal direction (the third straight line 63) of the opening 15 was 0° in a plan view and was smaller than 45°. In addition, the opening 15 used in Example 1 had a shape that overlaps 100% of the area of a shape obtained when the shape of the opening 15 is rotated by 180° in a plane parallel to the first substrate 10.

### Comparative Example 1

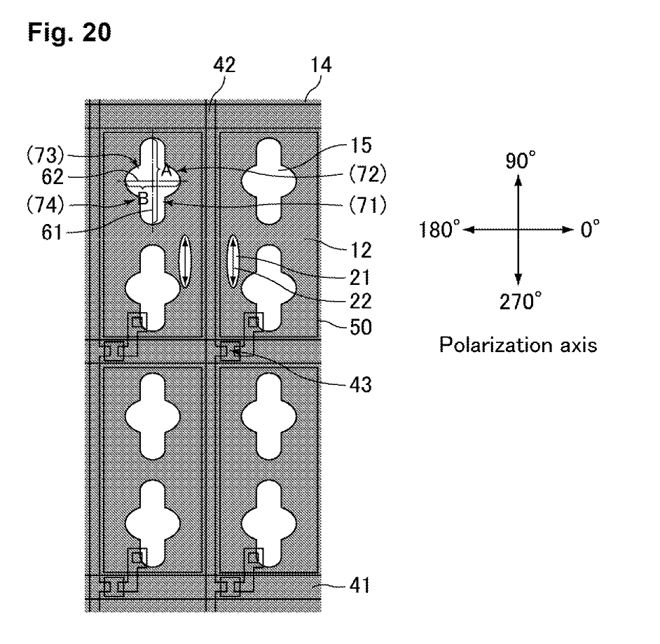

FIG. 20 is a schematic plan view of a liquid crystal display device according to Comparative Example 1. A liquid crystal display device 100A according to Comparative Example 1 has the same configuration as the liquid crystal display device 100A according to Example 1 except that the shape of an opening 15 of a counter electrode 14 is changed to the shape of FIG. 20.

The average slopes of the contour of the opening 15 used in Example 1 were obtained in the same manner as in Example 1.

Table 3 given below shows the average slopes of the contour portions of the opening 15 used in Example 1 and the average slope of the entire contour.

TABLE 3

| | | | | | Average |
|---|---|---|---|---|---|
| | Average slopes of contour portions | | | | slope of |
| | On first | On second | On third | On fourth | entire |
| | quadrant | quadrant | quadrant | quadrant | contour |
| Comparative | −0.87 | 0.87 | −0.87 | 0.87 | 0 |
| Example 1 | | | | | |

Table 3 shows that the average slopes of the first and third contour portions on a first quadrant 71 and a third quadrant 73 had negative signs, the slopes of the second and fourth contour portions on a second quadrant 72 and a fourth quadrant 74 had positive signs, and the sign of the average slope of each contour portion differed from the sign of the average slope of each of the two adjacent contour portions. In addition, the average slope of the entire contour was zero.

### Comparison Between Example 1 and Comparative Example 1

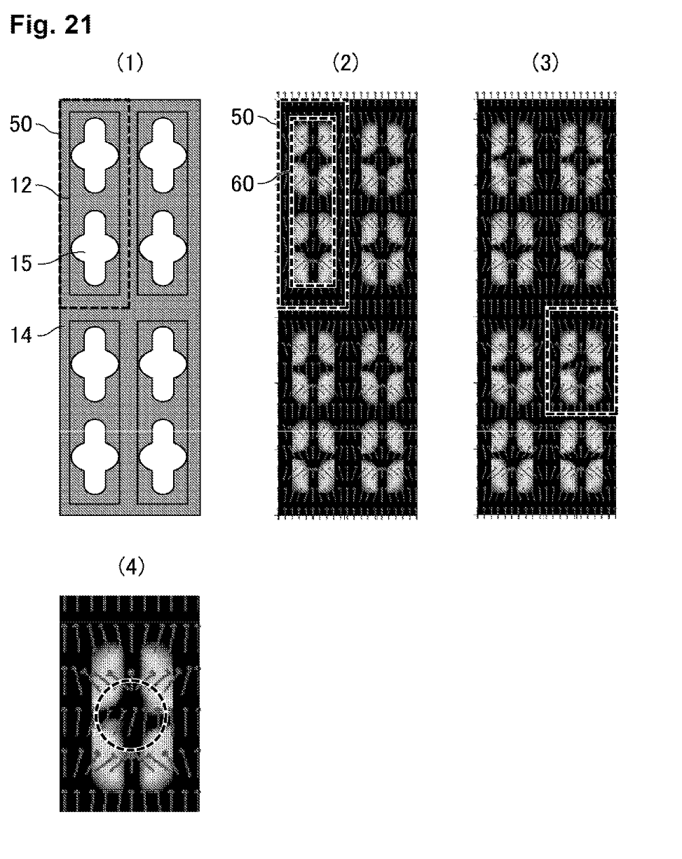

The alignment distribution of the liquid crystal molecules 21 in the ON state of each of the liquid crystal display devices 100A according to Example 1 and Comparative Example 1 will be described with reference to FIGS. 10 and 21.

FIG. 10 is a view relating to the liquid crystal display device 100A according to Example 1, with (1) being a schematic plan view showing a counter electrode and pixel electrodes, (2) being a plan view showing the simulation result of the alignment distribution of liquid crystal molecules when 5.5 V is applied, and (3) being a plan view showing the simulation result of the alignment distribution of liquid crystal molecules when 6.0 V is applied. FIG. 21 is a view relating to the liquid crystal display device according to Comparative Example 1, with (1) being a schematic plan view showing a counter electrode and pixel electrodes, (2) being a plan view showing the simulation result of an alignment distribution of liquid crystal molecules when 4.5 V is applied, (3) being a plan view showing the simulation result of the alignment distribution of liquid crystal molecules when 5.0 V is applied, and (4) being an enlarged plan view of a portion enclosed with a dotted line in (3). LCD-Master 3D available from Shintech Co., Ltd. was used for simulation in each example and comparative example.

As indicated by the simulation result in FIG. 21(2), when a voltage of 4.5 V was applied to the liquid crystal display device 100A according to Comparative Example 1, four liquid crystal domains were formed for each opening 15, and the same alignment state appeared in each of the four units of display 50. However, when a voltage of 5.0 V is applied to the liquid crystal display device 100A of Comparative Example 1, the alignment state of the portion of the liquid crystal molecule 21 in the central portion of the opening becomes unstable, and the liquid crystal molecules 21 rotate in the central portion in some of the openings 15, as shown in the portion surrounded by the dotted line in FIG. 21(3) and FIG. 21(4). This means that although the same gray scale is being displayed, the transmittance varies because alignments differ depending on the unit of display 50. Therefore, it was found that the liquid crystal display device 100A according to Comparative Example 1 could be used up to 4.5 V, but could not be used at 5.0 V or more.

In contrast, as indicated by the simulation results in FIGS. 10(2) and 10(3), in the liquid crystal display device 100A according to Example 1, using the opening 15 satisfying (condition 1) and (condition 2) described above made it possible to form four liquid crystal domains for each opening 15 in the opening portion 60 at the time of voltage application, rotate the liquid crystal molecules 21 in the central portion of the opening 15 in a predetermined azimuth direction, and couple two of the four liquid crystal domains in the central portion of the opening 15.

As a result, even when high voltages of 5.5 V and 6.0 V were applied, the liquid crystal molecules 21 can assume the same alignment state in all units of display 50, and in the liquid crystal display device 100A according to Example 1, there was no problem concerning differences in transmittance depending on the unit of display 50. Therefore, the liquid crystal display device 100A according to Example 1 allowed application of a high voltage and can increase the transmittance. Specifically, at the time of white display, when a voltage of 6.0 V was applied to the liquid crystal display device 100A according to Example 1, the transmittance was 23.8%. In contrast, when a voltage of 4.5 V was applied to the liquid crystal display device 100A according to Comparative Example 1 at the time of white display, the transmittance was 21.2%. As described above, the liquid crystal display device 100A according to Example 1 could increase the transmittance by 12.3% as compared with the liquid crystal display device 100A according to Comparative Example 1.

The difference in transmittance between the liquid crystal display devices 100A according to Example 1 and Comparative Example 1 will be considered below.

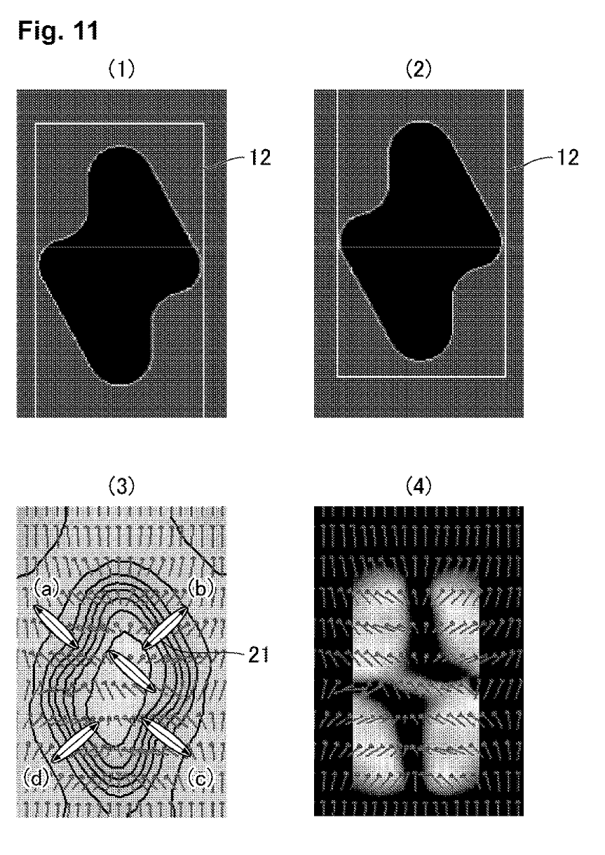

FIG. 11 is a view relating to Example 1, with (1) being a plan view showing one opening in a counter electrode and pixel electrodes, (2) being a view obtained by rotating (1) by 180° in a plane parallel to the first substrate, (3) being a view showing the electric field distribution at the time of voltage application at the opening in (1), and (4) being a view showing the transmittance distribution at the time of voltage application at the opening in (1).

As shown in FIGS. 11(1) and 11(2), the shape of the opening 15 used in Example 1 is asymmetric with respect to the initial alignment azimuth direction 22 of the liquid crystal molecules 21, and is identical to the shape obtained by rotating the shape of the opening 15 by 180° in a plane parallel to a first substrate 10.

As shown in FIGS. 11(3) and 11(4), by using the opening 15 as in Example 1, fringe electric fields were generated in four azimuth directions at the time of voltage application, and liquid crystal molecules 21 rotated like the liquid crystal molecules 21 indicated by (a) to (d). In addition, because the fringe electric fields in the upper left and lower right directions are stronger than the fringe electric fields in the upper right and the lower left directions, the liquid crystal molecules 21 in the central portion rotated in the direction of the stronger fringe electric fields. This made it possible to rotate the liquid crystal molecules 21 in the central portion of the opening 15 in a predetermined azimuth direction, thereby improving the response speed and the transmittance of the liquid crystal display device 100A. As described above, when the shape of the opening 15 is asymmetric with respect to the initial alignment azimuth direction 22 of the liquid crystal molecules 21 and is identical to the shape obtained by rotating the shape of the opening 15 by 180° in a plane parallel to a first substrate 10, such electric fields can be efficiently generated. The shapes of the openings in all other examples described later also satisfy this condition.

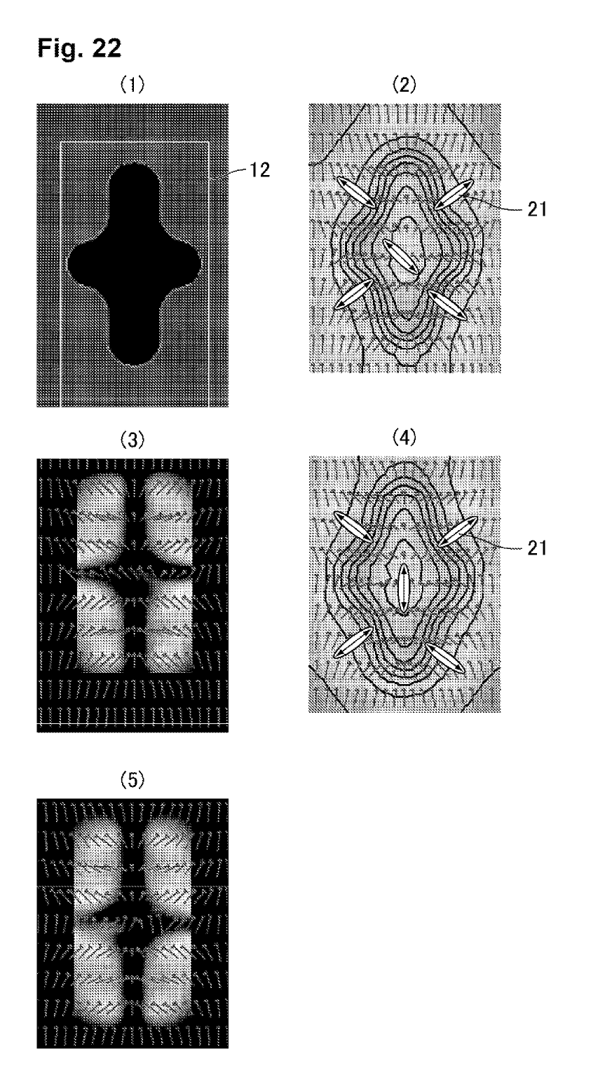

FIG. 22 is a view relating to Comparative Example 1, with (1) being a plan view showing one opening in a counter electrode and pixel electrodes, (2) being a view showing electric field distribution 1 at the time of voltage application at the opening in (1), (3) being a view showing transmittance distribution 1 in the state in (2), (4) being a view showing electric field distribution 2 at the time of voltage application at the opening in (1), and (5) being a view showing transmittance distribution 2 in the state in (4).

In the case of using the counter electrode 14 according to Comparative Example 1, ideally, four liquid crystal domains are generated in four regions symmetrical with respect to the longitudinal direction and the transverse direction of the opening 15, and electric fields balance in the central portion of the opening 15 to inhibit the liquid crystal molecules 21 from rotating. However, in reality, when a high voltage is applied, an electric field in the central portion of the opening 15 is slightly distorted, the liquid crystal molecules 21 rotate to the left as shown in FIGS. 22(2) and 22(3), or the electric fields balance to inhibit the liquid crystal molecules 21 from rotating as shown in FIGS. 22(4) and 22(5). As described above, in Comparative Example 1, because the alignment state of the liquid crystal molecules 21 upon application of a high voltage varies depending on the unit of display 50, a high voltage cannot be applied, and as a result, the transmittance of the liquid crystal display device 100A decreases.

### Examples 2 to 4

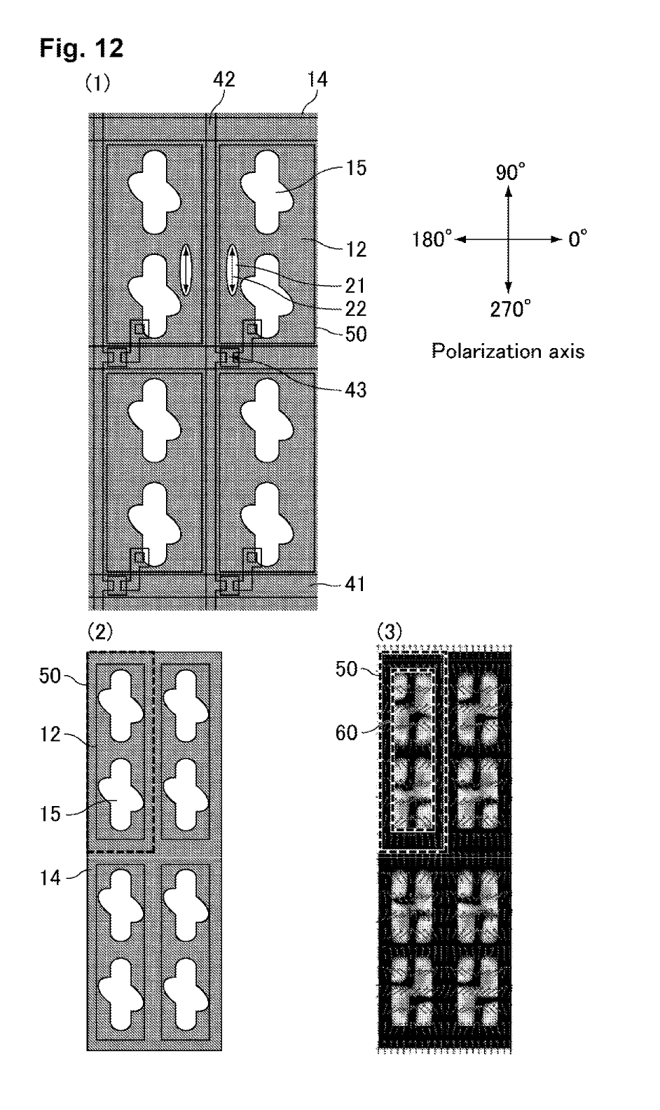

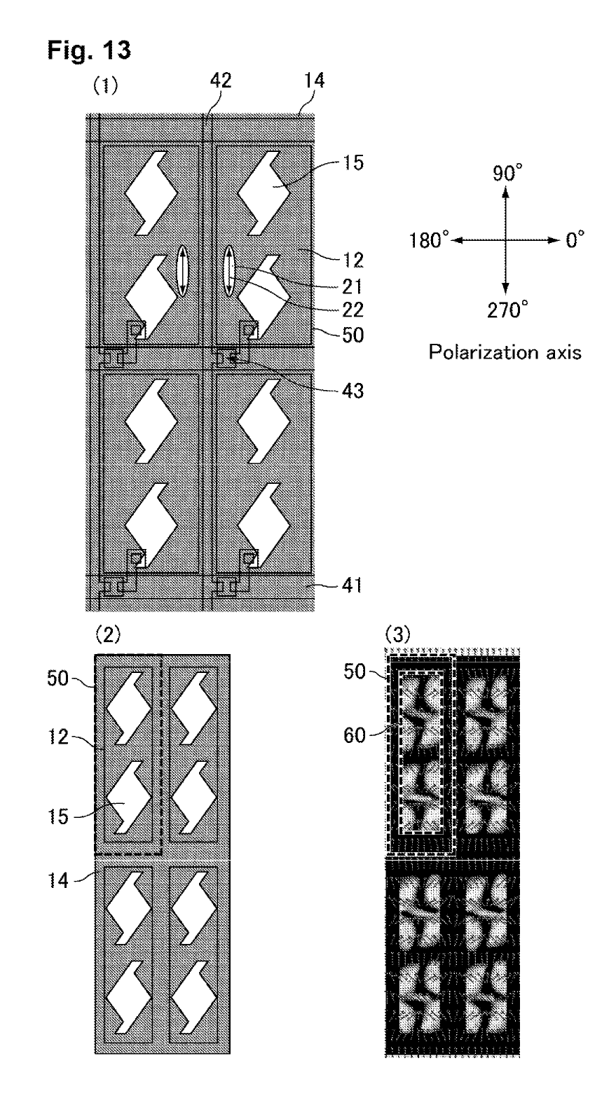

FIGS. 12 to 14 are views each relating to corresponding one of the liquid crystal display devices according to Examples 2 to 4, with (1) being a schematic plan view of the liquid crystal display device, (2) being a schematic plan view showing a counter electrode and pixel electrodes, and (3) being a plan view showing the simulation result of the alignment distribution of liquid crystal molecules when 6.0 V is applied. The liquid crystal display devices 100A according to Examples 2 to 4 each have the same configuration as the liquid crystal display device 100A according to Example 1 except that the shape of the opening 15 of the counter electrode 14 is changed. The liquid crystal display devices 100A according to Examples 2 to 4 used the counter electrodes 14 provided with the openings 15 shown in FIGS. 12 to 14. FIGS. 12 to 14 respectively show the initial alignment azimuth directions 22 of the liquid crystal molecules 21 according to Examples 2 to 4. FIGS. 3(2) to 3(4) show the relationships between the shapes of the openings 15 used in Examples 2 to 4 and the lengths A and B. FIGS. 5(2) to 5(4) show the relationships between the shapes of the openings 15 used in Examples 2 to 4 and the lengths C and D.

The average slopes of the contour portions of the openings 15 used in Examples 2 and 3 and the average slope of the entire contours were obtained in the same manner as in Example 1. The average slopes of the contour portions and the entire contour of the opening 15 used in Example 4 were obtained in the same manner as in Example 1 except that 211 straight lines parallel to the y-axis were drawn to divide the length of each contour portion projected on the x-axis into 210 portions. Assume that when the contour portions include a portion parallel to the first straight line 61 or the second straight line 62 like the opening 15 used in Example 3, the average slopes of the contour portions except for the parallel portion is obtained. Table 4 below shows the average slopes of the contour portions of the openings 15 used in Examples 2 to 4 and the average slope of the entire contours.

TABLE 4

| | | | | | Average |
|---|---|---|---|---|---|
| | Average slopes of contour portions | | | | slope of |
| | On first | On second | On third | On fourth | entire |
| | quadrant | quadrant | quadrant | quadrant | contour |
| Example 2 | −0.17 | 1.24 | −0.17 | 1.24 | 0.54 |
| Example 3 | −0.68 | 0.23 | −0.68 | 0.23 | −0.23 |
| Example 4 | −0.48 | 0.26 | −0.48 | 0.26 | −0.11 |

Table 4 shows that the average slopes of the first and third contour portions on the first quadrant 71 and the third quadrant 73 had negative signs, the average slopes of the second and fourth contour portions on the second quadrant 72 and the fourth quadrant 74 had positive signs, and the sign of the average slope of each contour portion differed from the sign of the average slope of each of the two adjacent contour portions. In addition, the average slope of the entire contour was not zero.

Table 5 shows the lengths A to D and the angle formed between the initial alignment azimuth direction 22 of the liquid crystal molecules 21 and the longitudinal direction of the opening 15.

TABLE 5

| | | | | | Angle formed between initial |
|---|---|---|---|---|---|
| | | | | | alignment azimuth direction |
| | | | | | and longitudinal direction of |
| | A | B | C | D | opening |
| Example 2 | 11 | 4.9 | 11 | 4.9 | 0° |
| Example 3 | 11 | 7.5 | 11 | 7.5 | 0° |
| Example 4 | 10.5 | 7.2 | 10.5 | 7.2 | 0° |

Table 5 shows that the opening 15 used in Examples 2 to 4 satisfied A>B and C>D, and the longitudinal direction of the opening 15 was a direction parallel to a third straight line 63. The angle formed between the initial alignment azimuth direction 22 and the longitudinal direction of the opening 15 was 0° in a plan view and was smaller than 45°. In addition, the openings 15 used in Examples 2 to 4 each had a shape that overlaps 100% of the area of a shape obtained when the shape of the opening 15 is rotated by 180° in a plane parallel to the first substrate 10.

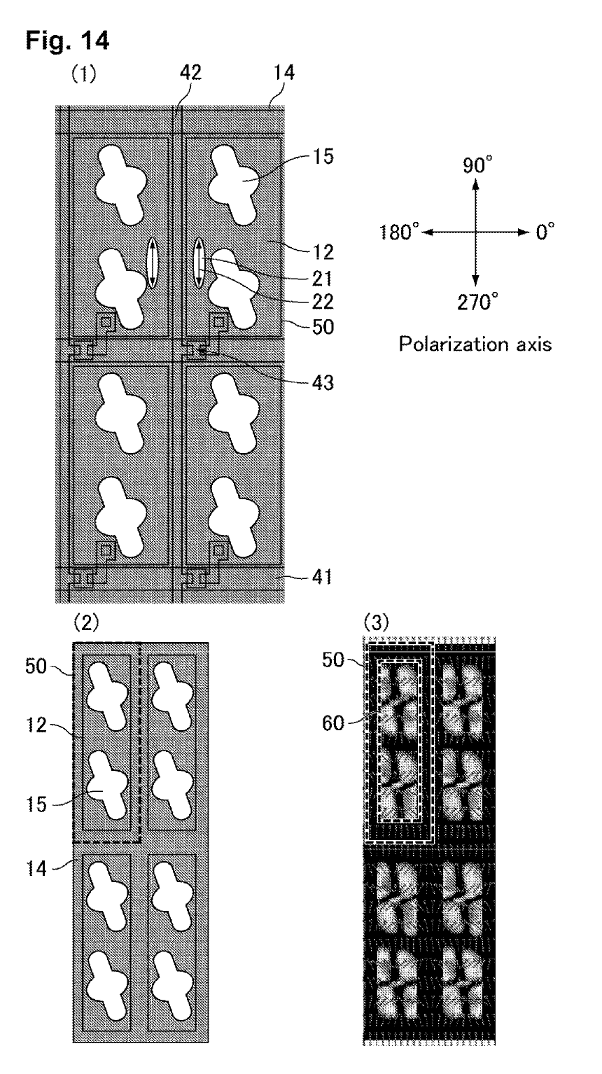

The alignment distribution of the liquid crystal molecules 21 in the ON state of each of the liquid crystal display devices 100A according to Examples 2 and 4 will be described with reference to FIGS. 12 and 14.

As indicated by the simulation results in FIGS. 12(3) to 14(3), in the liquid crystal display device 100A according to each of Examples 2 to 4, using the opening 15 satisfying (condition 1) and (condition 2) described above made it possible to form four liquid crystal domains for each opening 15 in an opening portion 60 at the time of voltage application, rotate the liquid crystal molecules 21 in the central portion of the opening 15 in a predetermined azimuth direction, and couple two of the four liquid crystal domains in the central portion of the opening 15.

As a result, even when a high voltage of 6.0 V is applied to each of the liquid crystal display devices 100A according to Examples 2 to 4, the liquid crystal molecules 21 could assume the same alignment state in all units of display 50, and the transmittance could be improved. Specifically, at the time of white display, when a voltage of 6.0 V was applied to the liquid crystal display devices 100A according to Examples 2 to 4, the transmittances were 24.7%, 24.2%, and 23.6%, respectively. Compared to the liquid crystal display device 100A according to Comparative Example 1, the liquid crystal display devices 100A according to Examples 2 to 4 could increase the transmittance by 16%, 14% and 11%, respectively.

### Example 5

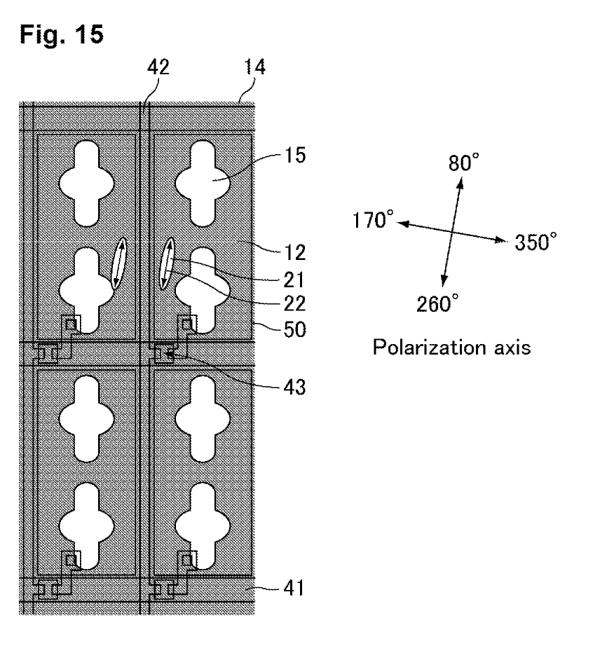

A liquid crystal display device 100A according to Example 5 has the same configuration as the liquid crystal display device 100A according to Example 1 except that the shape of an opening 15 of a counter electrode 14, an initial alignment azimuth direction 22 of liquid crystal molecules 21, and the polarization axis of a pair of polarizers are changed. FIG. 15 is a schematic plan view of the liquid crystal display device according to Example 5. The shape of the counter electrode 14 used in Example 5 was the same as in Comparative Example 1, but the initial alignment azimuth direction 22 of the liquid crystal molecules 21 according to Example 5 and the polarization axis of the pair of polarizers were tilted by 10° from the angle in Comparative Example 1. FIG. 15 shows the initial alignment azimuth direction 22 of the liquid crystal molecules 21. FIG. 3(5) shows the relationship between the shape of the opening 15 used in Example 5 and the lengths A and B. FIG. 5(5) shows the relationship between the shape of the opening 15 used in Example 5 and the lengths C and D.

The average slopes of the contour portions and the entire contour of the opening 15 used in Example 5 were obtained in the same manner as in Example 1 except that 211 straight lines parallel to the y-axis were drawn to divide the length of each contour portion projected on the x-axis into 210 portions. Table 6 below shows the average slopes of the contour portions of the opening 15 used in Example 5 and the average slope of the entire contour.

TABLE 6

| | | | | | Average |
|---|---|---|---|---|---|
| | Average slopes of contour portions | | | | slope of |
| | On first | On second | On third | On fourth | entire |
| | quadrant | quadrant | quadrant | quadrant | contour |
| Example 5 | −0.48 | 0.26 | −0.48 | 0.26 | −0.11 |

Table 6 shows that the average slopes of the first and third contour portions on a first quadrant 71 and a third quadrant 73 had negative signs, the average slopes of the second and fourth contour portions on a second quadrant 72 and a fourth quadrant 74 had positive signs, and the sign of the average slope of each contour portion differed from the sign of the average slope of each of the two adjacent contour portions. In addition, the average slope of the entire contour was not zero.

Table 7 shows the lengths A to D and the angle formed between the initial alignment azimuth direction 22 of the liquid crystal molecules 21 and the longitudinal direction of the opening 15.

TABLE 7

| | | | | | Angle formed between initial |
|---|---|---|---|---|---|
| | | | | | alignment azimuth direction |
| | | | | | and longitudinal direction of |
| | A | B | C | D | opening |
| Example 5 | 10.5 | 7.2 | 11 | 7.5 | 10° |

Table 7 shows that the opening 15 used in Example 5 satisfied A>B and C>D, and the longitudinal direction of the opening 15 was a direction parallel to a third straight line 63. The angle formed between the initial alignment azimuth direction 22 and the longitudinal direction of the opening 15 was 10° in a plan view and was smaller than 450. In addition, the opening 15 used in Example 1 had a shape that overlaps 100% of the area of a shape obtained when the shape of the opening 15 is rotated by 180° in a plane parallel to a first substrate 10.

The alignment distribution of the liquid crystal molecules 21 in the ON state of the liquid crystal display device 100A according to Example 5 will be described with reference to FIG. 16. FIG. 16 is a view relating to the liquid crystal display device according to Example 5, with (1) being a schematic plan view showing a counter electrode and pixel electrodes, (2) being a plan view showing the simulation result of the alignment distribution of liquid crystal molecules when 5.5 V is applied, and (3) being a plan view showing the simulation result of the alignment distribution of liquid crystal molecules when 6.0 V is applied. As indicated by the simulation results in FIGS. 16(2) and 16(3), in the liquid crystal display device 100A according to Example 5, using the opening 15 satisfying (condition 1) and (condition 2) described above made it possible to form four liquid crystal domains for each opening 15 at the time of voltage application, rotate the liquid crystal molecules 21 in the central portion of the opening 15 in a predetermined azimuth direction, and couple two of the four liquid crystal domains in the central portion of the opening 15.

As a result, even when high voltages of 5.5 V and 6.0 V are applied, the liquid crystal molecules 21 can assume the same alignment state in all the units of display 50, and in the liquid crystal display device 100A according to Example 5, there was no problem that the transmittance differed depending on the unit of display 50. Therefore, the liquid crystal display device 100A according to Example 5 allowed application of a high voltage and could increase the transmittance. Specifically, at the time of white display, when a voltage of 6.0 V was applied to the liquid crystal display device 100A according to Example 5, the transmittance was 23.9%. In contrast, when a voltage of 4.5 V was applied to the liquid crystal display device 100A according to Comparative Example 1 at the time of white display, the transmittance was 21.2%. As described above, the liquid crystal display device 100A according to Example 5 could increase the transmittance by 12.7% as compared with the liquid crystal display device 100A according to Comparative Example 1.

### Additional Remarks

One aspect of the present invention may be a liquid crystal display device sequentially including: a first substrate; a liquid crystal layer containing liquid crystal molecules; and a second substrate, wherein the first substrate includes a first electrode, a second electrode provided closer to the liquid crystal layer than the first electrode is, and an insulating film provided between the first electrode and the second electrode, an opening is formed in the second electrode, the liquid crystal molecules are aligned parallel to the first substrate in a voltage non-applied state in which no voltage is applied between the first electrode and the second electrode, and with a contour of the opening divided into four by a first straight line longest among lines dividing the opening in the direction parallel to an initial alignment azimuth direction of the liquid crystal molecules and a second straight line longest among lines dividing the opening in the direction orthogonal to the initial alignment azimuth direction, the sign of the average slope of each of the divided contour portions differs from the signs of the average slopes of two adjacent contour portions, and the average slope of the entire contour of the opening is not zero.

When the sign of the average slope of each contour portion differs from the sign of the average slope of each of the two adjacent contour portions, it is possible to generate an electric field for rotating the liquid crystal molecules 21 in the opposite azimuth direction in the adjacent contour portions. When the average slope of the entire contour of the opening is not zero, the shape of the opening is asymmetric with respect to the initial alignment azimuth direction of the liquid crystal molecules, and the rotation of the liquid crystal molecules in the central portion of the opening can be determined in one azimuth direction. This makes it possible to reduce the occurrence of a phenomenon in which the alignment state of the liquid crystal molecules differs depending on the unit of display at the time of applying a high voltage and to stabilize the alignment of the liquid crystal molecules even when a high voltage is applied in all units of display. Therefore, a sufficiently high voltage can be applied and the transmittance can be improved.

Openings satisfying the above-mentioned conditions can be formed without taking particularly complicated shapes, and thus it is possible to achieve high resolution.

With the longer of the first straight line and the second straight line dividing the opening being defined as an x-axis and the shorter of the first straight line and the second straight line dividing the opening being defined as a y-axis or, with one of the first straight line and the second straight line being defined as the x-axis and the other as the y-axis in the case where the first straight line and the second straight line dividing the opening have the same length, the average slope of each of the contour portions on a first quadrant and a third quadrant may be negative, and the average slope of each of the contour portions on a second quadrant and a fourth quadrant may be positive. According to this aspect, because the shape of the opening can be further simplified, higher resolution can be achieved.

The liquid crystal molecules may have positive anisotropy of dielectric constant. According to this aspect, liquid crystal molecules having a relatively low viscosity can be used, and hence the response speed can be further improved.

The relation A>B may hold, where A represents a length of the opening on the first straight line and B represents a length of the opening on the second straight line. According to this aspect, the transmittance and the alignment stability can be further improved.

An angle formed between the initial alignment azimuth direction and a longitudinal direction of the opening may be not more than 45° in a plan view. According to this aspect, the transmittance and the alignment stability can be further improved.

The liquid crystal molecules may have negative anisotropy of dielectric constant.

The relation A<B may hold, where A represents a length of the opening on the first straight line and B represents a length of the opening on the second straight line. According to this aspect, the transmittance and the alignment stability can be further improved.

The angle formed between the initial alignment azimuth direction and the longitudinal direction of the opening may be 45° or more in a plan view. According to this aspect, the transmittance and the alignment stability can be further improved.

In a voltage applied state in which a voltage is applied between the first electrode and the second electrode, the liquid crystal molecules may rotate in the same azimuth direction in a central portion of the opening. According to this aspect, this can more reliably reduce the occurrence of a phenomenon in which the alignment state of the liquid crystal molecules differs depending on the unit of display at the time of applying a high voltage.

A shape of the opening may be the same as a 180° rotated shape in a plane parallel to the first substrate. According to this aspect, it is possible to achieve a desired alignment more efficiently.

In at least a white display state, first, second, and third liquid crystal domains may be present on the opening, the first liquid crystal domain may include two domain portions located separately in two of four regions adjacent to each other vertically and horizontally in a plan view and a coupling portion coupling the two domain portions and located in the central portion of the opening, the two regions being the upper right region and the lower left region or the lower right region and the upper left region, and the second and third liquid crystal domains may be located separately in the other two regions where the two domain portions are not located. According to this aspect, this can more reliably reduce the occurrence of a phenomenon in which the alignment state of the liquid crystal molecules differs depending on the unit of display at the time of applying a high voltage.

### REFERENCE SIGNS LIST

10 first substrate
11, 31 insulating substrate (for example, glass substrate)
12 pixel electrode (first electrode)
13 insulating layer (insulating film)
14 counter electrode (second electrode)
15 opening (slit)
16 longitudinal portion
17 protruding portion
20 liquid crystal layer
21 liquid crystal molecules
22 initial alignment azimuth direction
30 second substrate
32 color filter
33 overcoat layer
41 gate signal line (scanning conductive line)
42 source signal line (signal conductive line)
43 TFT
50 unit of display
60 opening portion
61 first straight line
62 second straight line
63 third straight line
64 fourth straight line
71 first quadrant.
72 second quadrant
73 third quadrant
74 fourth quadrant
81 first liquid crystal domain
81A domain portion
81B coupling portion
82 second liquid crystal domain
83 third liquid crystal domain
100A liquid crystal display device
A length of opening 15 on first straight line 61
B length of opening 15 on second straight line 62
C length of opening 15 on third straight line 63
D length of opening 15 on fourth straight line 64

1. A liquid crystal display device sequentially comprising:
a first substrate;
a liquid crystal layer containing liquid crystal molecules; and
a second substrate,
wherein the first substrate includes a first electrode, a second electrode provided closer to the liquid crystal layer than the first electrode is, and an insulating film provided between the first electrode and the second electrode,
an opening is formed in the second electrode,
the liquid crystal molecules are aligned parallel to the first substrate in a voltage non-applied state in which no voltage is applied between the first electrode and the second electrode, and
with a contour of the opening divided into four by a first straight line longest among lines dividing the opening in the direction parallel to an initial alignment azimuth direction of the liquid crystal molecules and a second straight line longest among lines dividing the opening in the direction orthogonal to the initial alignment azimuth direction,
the sign of the average slope of each of the divided contour portions differs from the signs of the average slopes of two adjacent contour portions, and the average slope of the entire contour of the opening is not zero.

2. The liquid crystal display device according to claim 1,
wherein with the longer of the first straight line and the second straight line dividing the opening being defined as an x-axis and the shorter of the first straight line and the second straight line dividing the opening being defined as a y-axis or, with one of the first straight line and the second straight line being defined as the x-axis and the other as the y-axis in the case where the first straight line and the second straight line dividing the opening have the same length, the average slope of each of the contour portions on a first quadrant and a third quadrant is negative, and the average slope of each of the contour portions on a second quadrant and a fourth quadrant is positive.

3. The liquid crystal display device according to claim 1,
wherein the liquid crystal molecules have positive anisotropy of dielectric constant.

4. The liquid crystal display device according to claim 3,
wherein the relation A>B holds, where A represents a length of the opening on the first straight line and B represents a length of the opening on the second straight line.

5. The liquid crystal display device according to claim 3,
wherein an angle formed between the initial alignment azimuth direction and a longitudinal direction of the opening is not more than 45° in a plan view.

6. The liquid crystal display device according to claim 1,
wherein the liquid crystal molecules have negative anisotropy of dielectric constant.

7. The liquid crystal display device according to claim 6,
wherein the relation A<B holds, where A represents a length of the opening on the first straight line and B represents a length of the opening on the second straight line.

8. The liquid crystal display device according to claim 6,
wherein an angle formed between the initial alignment azimuth direction and a longitudinal direction of the opening is not less than 45° in a plan view.

9. The liquid crystal display device according to claim 1,
wherein in a voltage applied state in which a voltage is applied between the first electrode and the second electrode, the liquid crystal molecules rotate in the same azimuth direction in a central portion of the opening.

10. The liquid crystal display device according to claim 1,
wherein a shape of the opening is the same as a 180° rotated shape in a plane parallel to the first substrate.

11. The liquid crystal display device according to claim 1,
wherein in at least a white display state, first, second, and third liquid crystal domains are present on the opening,
the first liquid crystal domain includes two domain portions located separately in two of four regions adjacent to each other vertically and horizontally in a plan view and a coupling portion coupling the two domain portions and located in the central portion of the opening, the two regions being the upper right region and the lower left region or the lower right region and the upper left region, and
the second and third liquid crystal domains are located separately in the other two regions where the two domain portions are not located.
